(19) United States
(12) Patent Application Publication
(10) Pub. No.: US 2022/0350810 A1
(43) Pub. Date: Nov. 3, 2022

(54) DATA-DRIVEN ENRICHMENT OF DATABASE ELEMENTS

(71) Applicant: AT&T Intellectual Property I, L.P., Atlanta, GA (US)

(72) Inventors: Subhabrata Majumdar, Jersey City, NJ (US); Rajat Malik, Metuchen, NJ (US)

(21) Appl. No.: 17/306,300

(22) Filed: May 3, 2021

(51) Int. Cl. G06F 16/2457; G06N 20/00; G06N 7/00

(52) U.S. Cl. CPC G06F 16/24578; G06N 20/00; G06N 7/005

(57) ABSTRACT

Techniques for determining, modifying, and correcting data elements of documents, tables, and databases are presented. A data management component (DMC) can determine and extract entities of a group of entities, and relationships between entities, in documents, tables, and databases based on analysis of the entities and information relating thereto. DMC can determine a trained model representative of the entities and their relationships based on the relationships. For a subsequently received entity, DMC can predict a relationship between the subsequent entity and an entity of the entity group based on the model. DMC can determine candidate data modifications associated with the subsequent entity based on the relationship between the subsequent entity and the entity. DMC can rank the candidate data modifications based on probabilities that the candidate data modifications are a correct data modification, wherein data modification information relating to the ranking can be presented as an output.

### TECHNICAL FIELD

The subject disclosure relates generally to electronic information processing, e.g., to detecting data-driven enrichment of database elements.

### BACKGROUND

Companies, organizations, and users can utilize and analyze data, such as data stored in databases and tables, for a variety of reasons, including to develop technology and products and make business decisions. The data can comprise raw data and/or processed data. There often can be errors in data, missing data values, and/or data that is not readily understood (e.g., word abbreviations or acronyms). Manual correction of errors in data or missing data values, or manual interpretation of data, by users can be undesirably time intensive, particularly when there is a large amount of data involved.

The above-described description is merely intended to provide a contextual overview relating to electronic information processing, and is not intended to be exhaustive.

### BRIEF DESCRIPTION OF THE DRAWINGS

FIG. 1 depicts a block diagram of an example, non-limiting system that can desirably determine, modify, correct, and organize data elements of documents, tables, and databases, in accordance with various aspects and embodiments of the disclosed subject matter.

FIG. 2 depicts a block diagram of an example, non-limiting data management component (DMC), in accordance with various aspects and embodiments of the disclosed subject matter.

FIG. 3 illustrates a block diagram of an example non-limiting data management process that can be employed and performed by the DMC to desirably determine, modify, correct, and organize data elements of electronic documents, tables, and databases, in accordance with various aspects and embodiments of the disclosed subject matter.

FIG. 4 depicts a diagram of an example, non-limiting entity relationship mapping, in accordance with various aspects and embodiments of the disclosed subject matter.

FIG. 5 illustrates a diagram of example, non-limiting entity relationships, in accordance with various aspects and embodiments of the disclosed subject matter.

FIG. 6 depicts a diagram of other example, non-limiting entity relationships, in accordance with various aspects and embodiments of the disclosed subject matter.

FIG. 7 depicts an example block diagram of an example communication device operable to engage in a system architecture that facilitates wireless communications according to one or more embodiments described herein.

FIG. 8 illustrates a flow diagram of an example, non-limiting method that can desirably determine, modify, correct, and organize data elements of documents, tables, and databases, in accordance with various aspects and embodiments of the disclosed subject matter.

FIG. 9 depicts a flow diagram of an example, non-limiting method that can evaluate a group of candidate data modifications associated with an entity, select a desired candidate data modification from the group, and modify information of or associated with the entity based on the desired candidate data modification, in accordance with various aspects and embodiments of the disclosed subject matter.

FIG. 10 illustrates an example block diagram of an example computing environment in which the various embodiments of the embodiments described herein can be implemented.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular network environment or standard).

Companies, organizations, and users can utilize and analyze data, such as data stored in databases and tables, for a variety of reasons, including to develop technology and products and make business decisions. The data can comprise raw data and/or processed data. Users, such as data scientists, analysts, and administrators, can spend an undesirable (e.g., an excessive) amount of time in data preparation (e.g., cleaning of data, manually identifying names of columns, manually identifying and remedying erroneous or missing data values), as manual correction of errors in data or missing data values, or manual interpretation of data, by users can be undesirably time intensive, particularly when there is a large amount of data involved. Also, data element names (e.g., table and column names) often can be cryptic. For instance, data element names sometimes can comprise terminology, abbreviations, or acronyms, such as company or technology specific terminology, abbreviations, or acronyms. Such terminology, abbreviations, or acronyms may not be readily understood by all users of the data. Interpretation of such terminology, abbreviations, or acronyms by users can be subjective, and there can be human-level uncertainty in data curation. Incorrect identification of data elements by users can lead to erroneous use of such incorrect data in analysis and modeling. Also, some cryptic data may end up being ignored by users if its interpretation is not understood, which can undesirably leave valuable information out of data analyses.

Building database expertise can be difficult and can take a considerable amount of time. For large enterprises (e.g., large companies or organizations), it can be significantly more difficult to build database expertise at scale and manually. For instance, subject matter experts can spend a considerable amount of time creating dictionaries, which can place an undesirably large cost on individual and project times. Furthermore, building dictionaries to decrypt data elements for a large enterprise generally is not readily or sufficiently scalable.

There are a few traditional techniques for data preparation, correction of errors in data or missing data values, and interpretation of data. However, such traditional techniques can be relatively limited in scope and can have insufficient capabilities, particularly with regard to databases, tables, and data associated therewith. For instance, spelling and grammar checking applications and predictive text applications can be used to auto-correct spelling and grammar. However, such traditional applications generally can be geared towards writing, rather than being specific to data elements, such as data elements of a database or table, and such traditional applications can have various and significant deficiencies when used to process and prepare data associated with databases or tables. Also, traditional manual ad-hoc analysis to process and prepare data, including determining data types of data, combined with subject matter experts to make decisions regarding demystifying or decrypting data elements can be undesirably time intensive, manual labor intensive, and costly.

The disclosed subject matter can overcome these and other problems associated with processing information, including information in databases and tables, and enterprise-specific or technology-specific terminology.

To that end, the disclosed subject matter presents techniques, methods, and systems that can desirably determine, modify, correct, and organize data elements of documents (e.g., electronic documents), tables, and databases. A data management component (DMC) can determine a group of entities (e.g., nodes), and respective relationships (e.g., edges) between respective entities, in documents (e.g., electronic documents), tables, and databases, and can extract information relating to such entities and relationships from the documents, tables, and databases in a desired structured format, based at least in part on analysis of the documents, tables, and databases, including the entities, and information relating to the entities (e.g., data dictionaries, metadata, and/or external information). For instance, the DMC can create and train an information extraction model (e.g., a knowledge extraction model) that can extract information regarding the respective entities and the respective relationships between the respective entities from the group of electronic documents and the information relating to the entities. An entity can comprise, for example, a table, a database, a column of a table or database, a row of a table or database, and/or an item of data (e.g., data value) of a document, table, or database. The information relating to the entities can comprise, for example, data dictionaries or metadata associated with tables or databases, and/or external information, such as domain-specific information, freeform textual information relating to tables (e.g., freeform textual information that can provide column or table descriptions), and/or dictionaries that can relate to specific datasets.

The DMC also can determine and create an embedding model that can embed, and can be trained to be representative of, the respective entities and the respective relationships between respective entities (e.g., in a desired common representation or format) based at least in part on analysis of the information regarding the respective entities and the respective relationships between respective entities. In some embodiments, the DMC can employ an artificial intelligence (AI) component that can perform an AI analysis on the information relating to the entities, the relationships between entities, and/or other information (e.g., auxiliary information, such as entity weights and/or relationship weights). Based at least in part on the AI analysis results, the DMC can create the embedding model, in part, by embedding the entities, the relationships between entities, and/or the other information to a common representation, and can group the entities, the relationships between entities, and/or the other information in that space (e.g., common representational space) using AI (e.g., machine learning) and domain knowledge, as more fully described herein.

With regard to a new (e.g., a subsequent) entity associated with new data (e.g., a newly received table, database, or freeform information of an electronic document) that is received subsequent to the group of electronic documents, the DMC, employing the information extraction model and the embedding model, can predict or determine a new (e.g., a subsequent) relationship (e.g., an edge or a connection) between the new entity and another new entity identified in the new data, and/or between the new entity and one or more entities of the group of entities associated with the group of electronic documents based at least in part on an analysis of the new data and application of the information extraction model and the embedding model to the new data.

The DMC can determine candidate data modifications associated with the new entity based at least in part on the relationship between the new entity and one or more entities of the group of entities. A candidate data modification can comprise, for example, correction of an incorrect data value of a data entry (e.g., a data entry in a table or database), correction of a spelling error in a word in a data entry or column name in a table or database, insertion of a missing data value or word (e.g., into a field, cell, or column heading of a table or database), a correct expansion of an abbreviation or acronym associated with (e.g., representative of) a term, or other type of data modification, such as more fully described herein. The DMC can rank the candidate data modifications based at least in part on respective probabilities that the respective candidate data modifications are a correct data modification. The DMC can present (e.g., communicate or display) or facilitate presenting data modification information relating to the ranking as an output (e.g., via a communication device or interface component).

In some embodiments, a user (or multiple users), via the communication device or interface component, can review and evaluate data modification information relating to the ranking of the candidate data modifications associated with the new entity to facilitate determining which candidate data modification is the correct (e.g., accurate) data modification (if any) to utilize for the new entity (or at least determine the candidate data modification the user considers the correct data modification). As a result of the evaluation, the user can select the desired (e.g., correct or accurate) candidate data modification, and, in response, the DMC can modify the new entity (e.g., modify the information of or associated with the new entity) to be the modified information (e.g., modified column name, modified row name, modified data value, or other modified information) of the selected candidate data modification.

In certain embodiments, the DMC can evaluate the data modification information relating to the ranking of the candidate data modifications. Based at least in part on the results of the evaluation, the DMC can determine and select (e.g., automatically determine and select) the desired (e.g., correct or accurate) candidate data modification with regard to the new entity (or at least determine and select the candidate data modification the DMC considers the correct data modification). For example, during the evaluation, the DMC can apply a defined threshold probability (or corresponding defined threshold quality score). If the DMC determines that a candidate data modification (e.g., the highest ranking candidate data modification) of the candidate data modifications associated with the new entity satisfies (e.g., meets or exceeds; or is greater than or equal to) the defined threshold probability (or the corresponding defined threshold quality score), the DMC can determine (e.g., automatically determine) that such candidate data modification can be the desired candidate data modification, and can select such candidate data modification to be the desired candidate data modification. In response such selection, the DMC can modify the new entity (e.g., modify the information of or associated with the new entity) to be the modified information of the selected candidate data modification. In some embodiments, if the DMC determines that none of the candidate data modifications associated with the new entity satisfy the defined threshold probability (or the corresponding defined threshold quality score), the DMC can determine that the DMC is not to automatically select a candidate data modification, and can output (e.g., communicate) the data modification information relating to the ranking of the candidate data modifications to the user (e.g., via the communication device or interface component) for evaluation by the user. In certain embodiments, even when the DMC automatically selects a desired candidate data modification with regard to the new entity, a user(s) can review and evaluate the decision to select and selection of the candidate data modification by the DMC to enable the user(s) to determine whether the user(s) agrees with the decision and selection of the candidate data modification by the DMC and/or to override such selection and choose another candidate data selection for the new entity if the user(s) determines the selection of the candidate data modification by the DMC was incorrect.

The DMC also can feedback information (e.g., received from a user(s) or generated by the DMC) relating to the selection of the candidate data modification, including information relating to other candidate data modifications that were not selected, with regard to the new entity for further analysis by the embedding model, for example, to facilitate determining whether the ranking of the candidate data modifications was desirable (e.g., accurate, suitable, or optimal) and/or determining whether an adjustment is to be made to the ranking score, probability (e.g., probability value), and/or quality score, of one or more of the candidate data modifications in relation to the new entity (should another instance of the new entity appear again in a future document, table, or database) or a similar entity. For instance, if the highest ranked candidate data modification of the candidate data modifications is selected (e.g., by the user or the DMC), the DMC (e.g., data modification component, an evaluation component, model component, or embedding model of the DMC) can determine that the ranking of the candidate data modifications was accurate (at least with regard to the highest ranked candidate data modification being determined to be the correct candidate data modification), which can reinforce or enhance the accuracy of the embedding model and the ranking of the candidate data modifications with regard to the new entity or a similar entity. In some embodiments, in response, the DMC (e.g., data modification component, model component, or embedding model of the DMC) can increase the ranking score, probability, and/or quality score of the selected candidate data modification, and/or can decrease the ranking score, probability, and/or quality score of one or more of the other (not selected) candidate data modifications, in relation to the new entity or similar entity (in a future case where an instance of the new entity is encountered or a similar entity is encountered).

Conversely, if the highest ranked candidate data modification of the candidate data modifications is not selected (e.g., by the user or the DMC), and instead a lower ranked candidate data modification of the candidate data modifications is selected, the DMC (e.g., data modification component, an evaluation component, model component, or embedding model of the DMC) can determine that the ranking of the candidate data modifications was not accurate, which can indicate that the accuracy of the embedding model and the ranking of the candidate data modifications with regard to the new entity or a similar entity can be improved. In certain embodiments, in response, the DMC can increase the ranking score, probability, and/or quality score of the selected candidate data modification (e.g., to cause the selected candidate data modification to be the highest ranked candidate data modification in future cases), and/or can decrease the ranking score, probability, and/or quality score of one or more of the other (not selected) candidate data modifications (including the current highest ranked candidate data modification), in relation to the new entity or similar entity (in a future case where another instance of the new entity is encountered or a similar entity is encountered). The DMC also can update (e.g., modify) the embedding model based at least in part on the results of the modification of the new entity, the feedback information, and/or the results of evaluating the feedback information.

The DMC can store the previous version of the new entity, for reference, in a version control repository in a data store. The DMC also can store information relating to the modification of the new entity, the feedback information, the results of evaluating the feedback information, and/or information relating to the updated embedding model in the version control repository.

These and other aspects and embodiments of the disclosed subject matter will now be described with respect to the drawings.

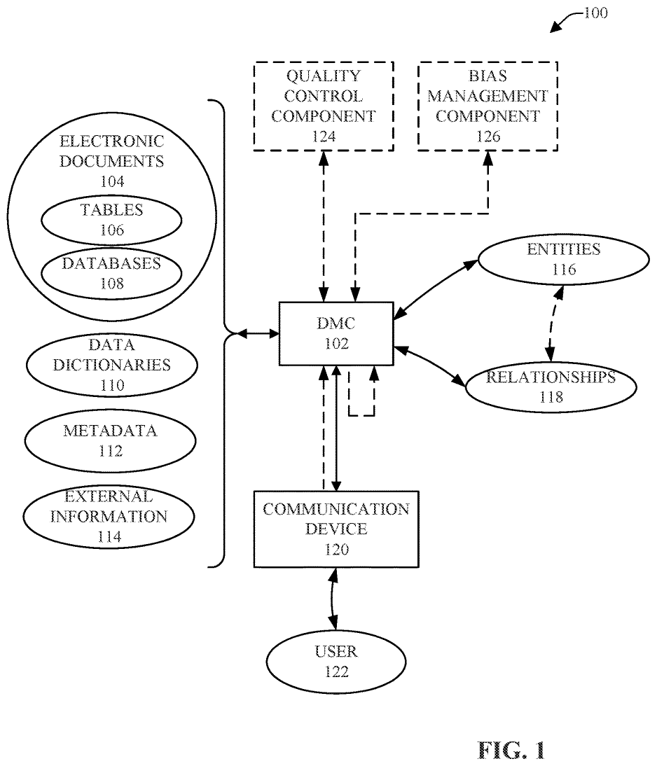

FIG. 1 depicts a block diagram of an example, non-limiting system 100 that can desirably (e.g., accurately and efficiently) determine, modify, correct, and organize data elements of documents (e.g., electronic documents), tables, and databases, in accordance with various aspects and embodiments of the disclosed subject matter. The system 100 can comprise a data management component (DMC) 102 that can analyze existing electronic documents, tables, and databases, and other information relating or relevant thereto, and based at least in part on such analysis, can desirably determine, modify, correct, and organize data elements of electronic documents, tables, and databases, such as subsequently received electronic documents, tables, and databases.

The DMC 102 can employ various techniques, including AI techniques (e.g., AI, machine learning, and/or neural network techniques), decrypt, clarify, modify, correct, and/or organize data elements of databases and tables, as well as freeform data elements, of electronic documents. The DMC 102 can use internal and external data (e.g., data samples, categories, column names, and/or other data) as input to machine learning models (e.g., information extraction model, embedding model) to train the machine learning models, such as described herein.

The DMC 102 can employ the trained machine learning models to correct and/or expand information of or associated with entities. As a non-limiting example, the DMC 102 can employ the trained machine learning models for desirable (e.g., accurate, suitable, or optimal) address imputation in geospatial data. For instance, city names in tables or databases sometimes can be abbreviated or misspelled (e.g., Chicago abbreviated as Chi or misspelled as something like Chuicago). The DMC 102, employing the trained machine learning models, can identify the abbreviation or misspelling of a city name in a table or database, and can expand the abbreviation to identify the full city name or correct a misspelling of the city name by learning word embeddings of the majority labels and suggesting alternate city names (e.g., candidate data modifications) to replace the abbreviation or misspelled city name with the full city name or correctly spelled city name.

As another non-limiting example, the DMC 102 can employ the trained machine learning models for desirable (e.g., accurate, suitable, or optimal) column name imputation for columns in tables or databases. For instance, column names in a table or database often can be abbreviated and/or can be in the form of an acronym (e.g., CBA). It sometimes can be difficult to understand the exact meaning of the abbreviation or acronym. For example, it can be difficult to understand whether CBA stands for customer billing address, customer billing account, call barring access, or something else. The DMC 102, employing the trained machine learning models, can identify the correct full (e.g., expanded) meaning of the abbreviation or acronym of a column name in a table or database, based on embeddings of similar columns, their relationships with other data elements, and/or the context of use of the abbreviation or acronym, and can suggest a desirable candidate data modification that can provide a more informative column name or description (e.g., a correct full column name or description identified and expanded from the abbreviation or acronym) for the column in the table or database.

In some embodiments, after determining a group of candidate data modifications associated with an entity, the DMC 102 can provide a ranked list of candidate data modifications regarding entities associated with electronic documents, databases, or tables to a user (e.g., database administrator or analyst) for evaluation to determine what modifications or corrections are to be made to the entities, wherein a desirable (e.g., correct, accurate, or suitable) candidate data modification associated with an entity can comprise corrected and/or expanded information relating to the entity. With regard to an entity, the user(s) can select the desired (e.g., correct) candidate data modification from the list, and the DMC 102 can implement the selected candidate data modification to modify information of or associated with the entity, in accordance with the candidate data modification, such as more fully described herein. In certain embodiments, the DMC 102, employing the models, can automatically determine and implement desired data modifications to correct, disambiguate, and/or expand information regarding the entities associated with electronic documents, databases, or tables, as more fully described herein.

The disclosed subject matter can provide a variety of improvements over conventional techniques for processing and discovering data, such as data associated with databases and tables, and managing data in databases and tables. For instance, the disclosed subject matter, employing the DMC 102, can desirably (e.g., accurately, efficiently, and/or optimally) enhance extraction of information from electronic documents, tables, and databases, including increasing the amount of information that can be extracted from electronic documents, tables, and databases, and can desirably enhance existing data to enable such data to be desirably usable in existing and future products and services. The DMC 102 also can desirably (e.g., accurately, efficiently, and/or optimally) create more informed models (e.g., information extraction model, embedding model) and gain additional insights into the data using richer data sources, and can enrich and structure existing data sources in an objective manner, rather than relying on the subjective individual expertise of database administrators. This can be beneficial, for example, since additional opportunities for automation in new areas can be expected to arise in the future, and the DMC 102, employing the techniques disclosed herein, can reduce, minimize, or remove subjective, human-level uncertainty in data curation, instead taking a data drive objective approach to data curation.

The disclosed subject matter, employing the DMC 102, also can desirably (e.g., accurately, efficiently, and/or optimally) reduce dependency on external data and ad-hoc approaches (e.g., meeting and/or emails with data engineers and extract/transform/load (ETL) groups) by utilizing the significant amount of data already available to an organization (e.g., a large enterprise) to create a desirable AI/machine learning-based approach. This can be desirable (e.g., useful, beneficial) since subject matter experts often can spend a considerable amount of time to create dictionaries, thereby placing a relatively large and undesirable cost on individual and project times, and since building dictionaries to decrypt data elements for a large enterprise typically does not scale well.

Further, the DMC 102 can enhance (e.g., improve) AI and machine learning (e.g., automatic machine learning (AML)) techniques. For instance, the AI and machine learning techniques employed by the DMC 102 can automate the process of training predictive models (e.g., information extraction model, embedding model) while also improving model performance of such models through data augmentation. The DMC 102 also can increase the pool of augmented data available by considering and analyzing data that otherwise may have been excluded from analysis (e.g., when using conventional techniques) due to ambiguity around the context of such data.

The DMC 102 also can create and utilize enhanced cross-dataset embedding models that can improve disambiguation of data and provide improved domain discovery. Conventionally, given a collection of tables, domain discovery often can remain elusive. The DMC 102 can utilize data-driven domain discovery that can desirably identify sets of terms that represent semantic concepts within a domain. While, conventionally, identifying these terms can be undesirably limited by the unambiguous terms that are available, the DMC 102, employing the disclosed techniques, can expand the set of terms to enhance disambiguation of terms and provide improved domain discovery.

Furthermore, it is noted that continuous integration and delivery (Cl/CD) of code and data elements can become increasingly important in technology platforms. The DMC 102, employing the techniques described herein, can desirably integrate external metadata and domain knowledge on data elements along with automation of processes (e.g., automation of training predictive models, and/or automation of modifying, correcting, disambiguating, and/or expanding data elements), and can continuously adapt to changing information on these external features. The DMC 102 can thus perform Cl/CD for database maintenance. The system, including the DMC 102, employing the described techniques, can desirably adapt and integrate new and/or enterprise-specific terminology, abbreviations, and/or acronyms, as well as their relationships with other entities (e.g., fifth generation (5G) technology or other next/future generation technology (e.g., next/future xG technology), radio access network (RAN), enhanced control, orchestration, management, and policy (ECOMP), evolved Node B (eNodeB), millimeter wave (mW), and other types of entities), as such new and/or enterprise-specific terminology, abbreviations, and/or acronyms come into existence, and thus, can give an enterprise a competitive efficiency edge in managing its data.

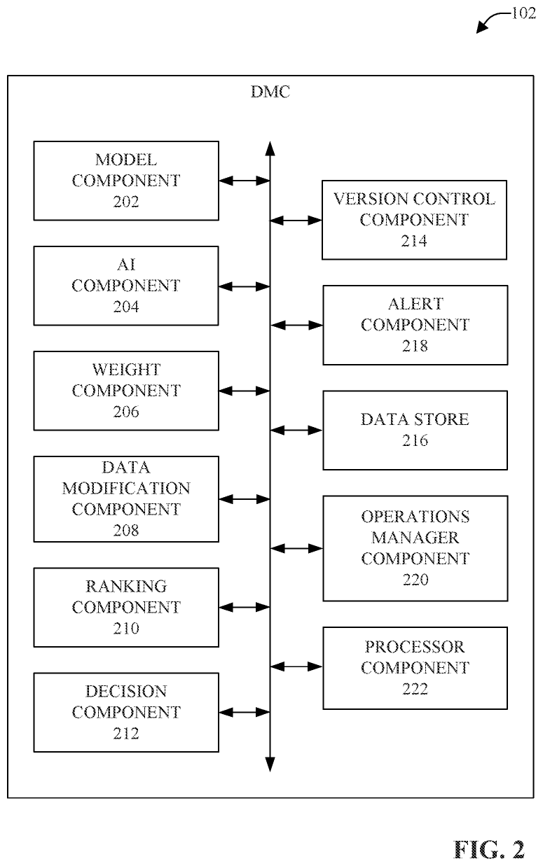

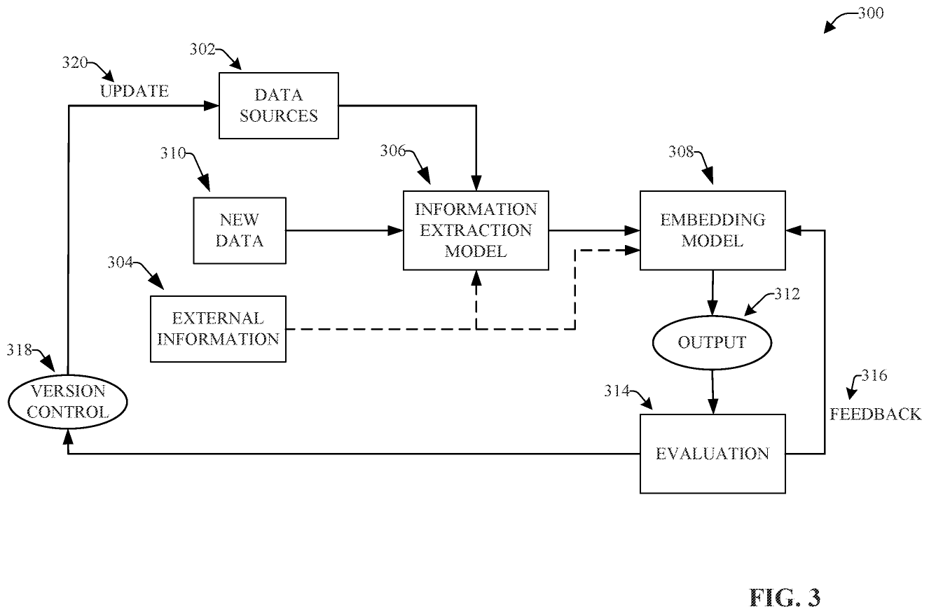

Referring to FIGS. 2 and 3 (along with FIG. 1), FIG. 2 depicts a block diagram of an example, non-limiting DMC 102, and FIG. 3 illustrates a block diagram of an example non-limiting data management process 300 that can be employed and performed by the DMC 102 to desirably determine, modify, correct, and organize data elements of electronic documents, tables, and databases, in accordance with various aspects and embodiments of the disclosed subject matter. The DMC 102 can receive (e.g., obtain) information relating to data elements from a variety of data sources (as indicated at reference 302 of the example data management process 300). For instance, the DMC 102 can receive information of existing electronic documents 104, which can comprise information of tables 106 and databases 108. The information of the electronic documents 104, tables 106, and databases 108 can be in a raw data form (e.g., the items of data contained in a table 106 or database 108) or can be at a desired aggregate level (e.g., a summary of information of a table(s) 106 or a database(s) 108). The electronic documents 104, tables 106, and databases 108 can relate to various topics or information, such as, for example, communications information (e.g., cellular communications, broadband communications, online communications, Internet protocol (IP)-based or packetized communications, or other type of communications), services information, products information, financial information, customer information, transaction information, geographical information, weather or climate information, food or nutritional information, medical information, entertainment information, sports information, demographic information (e.g., information relating to demographics of people, such as customers), and/or other desired types of topics or information. The DMC 102 also can receive data dictionaries 110 and metadata 112 relating to the tables 106 and databases 108, and the columns, rows, and data samples (e.g., data elements or items of data) with the tables 106 and databases 108, wherein the data dictionaries 110 and metadata 112 can provide definitional information, contextual information, or other information that can define or provide context for the tables 106, the databases 108, and/or at least some of the data elements of the tables 106 or databases 108 (e.g., a particular data dictionary can indicate that, in a particular table, a column name “carbs” is an abbreviation of the word “carbohydrates”).

In some embodiments, the DMC 102 also can receive external information 114 from one or more external data sources (as indicated at reference numeral 304 of the data management process 300), wherein the external information 114 can provide definitions or contextual information relating to entities to facilitate decrypting, clarifying, modifying, or correcting information associated with entities. The external information 114 can comprise, for example, dictionaries by third-party curators of specific types of datasets, domain-specific information (e.g., information specific to the cellular communications domain, information specific to the financial sector domain, information specific to the medical domain, or other domain-specific information), articles, and/or descriptions of tables 106, databases 108, or associated columns or rows as freeform textual information. The external information 114 may or may not pertain to particular tables 106 or databases 108.

The DMC 102 can comprise a model component 202 that can create (e.g., generate) various types of models, including an information extraction model (e.g., knowledge extraction model) and an embedding model, that can be utilized to facilitate identifying entities 116 (e.g., nodes) and relationships 118 (e.g., edges) between entities 116. The DMC 102, employing the model component 202, can analyze the information of the electronic documents 104, the tables 106, the databases 108, the data dictionaries 110, the metadata 112, and/or the external information. The data sources (e.g., electronic documents 104, tables 106, databases 108, data dictionaries 110, metadata 112, and/or external information 114) can comprise structured or unstructured information. In some embodiments, the model component 202 can determine, create, and/or train the information extraction model, wherein the information extraction model can receive the information from the data sources, analyze the information, and extract a group of entities 116 and respective relationships 118 between respective entities 116, and information relating to the respective entities 116 and respective relationships 118, from the documents 104, tables 106, databases 108, data dictionaries 110, metadata 112, and/or external information 114, in the desired structured format, based at least in part on the results of the analysis of such information (as indicated at reference numeral 306 of the data management process 300), as more fully described herein. In certain embodiments, as part of the analysis, the DMC 102 can comprise an AI component 204 that can utilize desired AI techniques and algorithms (e.g., AI, machine learning, and/or neural network techniques and algorithms), wherein the AI component 204 can operate in conjunction with the model component 202, and applying the desired AI techniques and algorithms, the AI component 204 can perform an AI analysis on the information of or relating to the electronic documents 104, the tables 106, the databases 108, the data dictionaries 110, the metadata 112, and/or the external information 114, to facilitate determining or identifying the respective entities 116 and the respective relationships 118 between the respective entities, as more fully described herein.

The group of entities 116 can comprise data elements of the documents 104, tables 106, and databases 108, wherein the data elements can comprise, for example, a table, a database, a column of a table or database, a row of a table or database, an item of data (e.g., a data value of data), metadata of or associated with a document or dataset (e.g., table or database), or other type of entity. A relationship 118 can be between two or more entities 116 of or associated with the electronic documents 104, tables 106, and databases 108. As some non-limiting examples, a relationship 118 can be between two datasets that can share columns, a relationship 118 can be between two or more columns that can denote the same field in multiple different datasets, a relationship 118 can be between a first column of a first dataset (e.g., first table or database) and a second column of a second dataset (e.g., the first column and the second column have the same name, same data, or a portion of data is the same), a relationship 118 can be between a column of the first dataset and a row of the first dataset (e.g., the column and the row intersect each other in the dataset), a relationship 118 can be between an item of data and a row and a column of a dataset (e.g., the item of data is located in a cell where the row and column intersect), a relationship 118 can be between a first item of data and a second item of data that are in a same row or a same column of a dataset, and/or a relationship 118 can be another type of relationship, such as described herein.

In certain embodiments, the DMC 102 also can determine auxiliary information that can be related to the entities 116 and relationships 118. For instance, the DMC 102, employing a weight component 206, can determine desired respective entity weights (e.g., node weights) to utilize for respective entities 116 and respective relationship weights (e.g., edge weights) to utilize for respective relationships 118 based at least in part on the results of analyzing information relating to the respective entities 116 and the respective relationships 118, and various factors comprising a type of entity 116, a type of relationship 118 between entities 116, a strength of the relationship 118 between entities 116, a level of significance (e.g., a determined level of criticality or importance) of an entity 116 or relationship 118, and/or other desired factors, as more fully described herein. As some non-limiting examples, the weight component 206 can determine desired entity or relationship weights (e.g., weight values) for entities 116 or relationships 118 between entities based at least in part on the number of columns that two datasets share, the number of columns in a dataset, a link an entity has to a raw data dictionary (e.g., external data dictionary), version information (e.g., at a high level, metadata on the entities 116 and relationships 118 between entities) and/or other factors. The weight component 206 can assign the respective entity weights to the respective entities 116 and the respective relationship weights to the respective relationships 118. The DMC 102 can utilize the respective entity weights and respective relationship weights to facilitate determining new (e.g., subsequently identified) relationships between new (e.g., subsequently identified) entities of or associated with new electronic documents, tables, or databases that can be received by the system 100, as more fully described herein.

In some embodiments, the DMC 102 (e.g., the model component 202 or another component of the DMC 102) can post-process the information relating to the entities 116 and relationships 118, and/or the information received from the data sources, using thresholding or pruning, to remove noise (e.g., noise in the data, such as outlier data) that may be in the information relating to the entities 116 and relationships 118, and/or the information received from the data sources, since noise in the data potentially can undesirably skew the results of data analysis and decisions based on such data analysis. For example, the DMC 102 can analyze such information and can apply desired threshold data values to such information to identify any items of information that can be outliers relative to other items of information (e.g., identify any items of information that satisfy (e.g., breach; or meet or exceed) an applicable threshold data value). The DMC 102 can remove any items of information determined to be outlier data from the information set.

In some embodiments, the model component 202 also can determine and create an embedding model that can embed the respective entities 116, the respective relationships 118 between respective entities 116, and the auxiliary information relating thereto, to a desired common representation, based at least in part on the results of an analysis of the information relating to the entities 116, the respective relationships 118 between the respective entities 116, and/or the auxiliary information (as indicated at reference numeral 308 of the data management process 300). The model component 202 can train the embedding model to be representative of the respective entities 116 and the respective relationships 118 between the respective entities 116, wherein the model component 202 can continue to train and refine (e.g., improve) the embedding model over time as additional information, including feedback information (e.g., feedback information relating to decisions regarding data modifications made by a user or by another component of the DMC 102), is input to the embedding model over time, as more fully described herein.

In certain embodiments, as part of such analysis, the DMC 102 can utilize the AI component 204, which can apply the desired AI techniques and algorithms, and can perform an AI analysis on the information of or relating to the entities 116, the respective relationships 118 between the respective entities 116, and/or the auxiliary information to map the structured or unstructured information relating to the entities 116 and relationships 118 to the desired common representation (e.g., a desired common structured format), as more fully described herein. The AI techniques and algorithms employed by the AI component 204 can comprise, for example, Word2vec, Seq2vec, Sentence2vec, Dot2vec, fastText, or another desired AI technique or algorithm. The DMC 102 (e.g., the model component 202 or AI component 204 of the DMC 102) can input the structured information relating to the entities 116 and relationships 118, represented in the common representation, into the embedding model for analysis (e.g., AI, machine learning, or neural network analysis), wherein the embedding model can be an AI-based embedding model (e.g., AI, machine learning, or neural network based embedding model).

In some embodiments, in addition to the relationship information (e.g., connectivity information) regarding the relationships 118 between respective entities 116, the model component 202 and/or AI component 204, in connection with creating and utilizing the embedding model, can receive and analyze information relating to particular domains (e.g., domain-specific information) associated with respective portions of the information received from data sources, and, based at least in part on the results of such analysis, can determine additional structural constraints, which can be informed by the domain knowledge gained from analysis of the information relating to the particular domains. The model component 202 and/or AI component 204, in connection with creating and utilizing the embedding model, can apply the respective additional structural constraints in connection with respective relationships 118 between respective entities 116 to make the embeddings of the respective entities 116 and the respective relationships 118 between respective entities 116 context-specific, which can enhance the embeddings of the respective entities 116 and the respective relationships 118 between respective entities 116. The model component 202 (e.g., employing the embedding model) and/or AI component 204 can apply the respective additional structural constraints, in connection with the respective relationships 118 between respective entities 116, when determining (e.g., computing) the embeddings of the embedding model or as a post-processing operation.

With further regard to the information extraction model, the DMC 102 can utilize the information extraction model to determine and extract new (e.g., subsequent) relationships between entities 116 of the group of entities or new entities identified in new data (e.g., new or subsequently received data with regard to the DMC 102). For instance, the DMC 102 can receive new (e.g., newly received) data, such as new electronic documents, new tables, and/or new databases from one or more data sources, wherein the new electronic documents, tables, and/or databases can be input to the information extraction model for analysis (as indicated at reference numeral 310 of the data management process 300). As described herein, the information extraction model has been trained, based at least in part on information obtained from the data sources (e.g., the electronic documents 104, tables 106, databases 108, data dictionaries 110, metadata 112, and/or external information 114), to enable the information extraction model to desirably (e.g., suitably or optimally) extract information regarding entities and relationships between entities in documents, tables, or databases. The model component 202 and/or the AI component 204, employing the information extraction model, can analyze the new data, including analyzing the new data in relation to the previous data (e.g., the electronic documents 104, tables 106, databases 108, data dictionaries 110, metadata 112, and/or external information 114). Based at least in part on the results of such analysis, the information extraction model of the model component 202 can extract information regarding new entities from the new data, extract information regarding respective new relationships between respective new entities from the new data, and/or extract information regarding respective new relationships between respective new entities and respective entities 116 of the group of entities from the new data and the previous data in the desired structured format (e.g., as indicated at reference numeral 306 of the data management process 300). The model component 202 also can determine auxiliary information, such as respective entity weights that can be applied to the respective new entities or respective relationship weights that can be applied to the respective new relationships.

The model component 202 and/or the AI component 204, employing the embedding model, can predict or determine the new entities, the new relationships (e.g., edges or connections) between respective new entities, and/or the new relationships (e.g., new relationships 118) between the respective new entities and respective entities 116, and can embed the new entities, the new relationships between respective new entities, and/or the new relationships between the respective new entities and respective entities 116 in the desired common representation in the embedding model, based at least in part on the results of an analysis (e.g., AI-based analysis) of the information regarding the new entities, the information regarding the respective new relationships between the respective new entities, and/or the information regarding the respective new relationships between the respective new entities and the respective entities 116, to generate an updated embedding model (e.g., as indicated at reference numeral 308 of the data management process 300).

In some embodiments, the DMC 102 can comprise a data modification component 208 of or associated with (e.g., communicatively connected to) the model component 202. Based at least in part on the respective relationships 118 between respective entities 116, including new relationships between entities, as predicted or determined by the model component 202 using the embedding model, the data modification component 208 can determine candidate (e.g., suggested, recommended, or proposed) data modifications for entities 116, such as a new entity, that can be evaluated to determine which (if any) candidate data modification of the candidate data modifications is to be used to modify information of an entity to correct the information of the entity. In certain embodiments, the data modification component 208 can include a ranking component 210 that can rank respective candidate data modifications associated with an entity 116 in order of respective probabilities that the respective candidate data modifications are the desired (e.g., correct, accurate, suitable, or optimal) data modification to be used to modify the information of the entity 116.

For instance, with regard to an entity 116 (e.g., new entity) under consideration, the data modification component 208 and/or the AI component 204 can analyze information (e.g., structured or formatted information) relating to the respective relationships 118 between the respective entities 116, comprising the entity 116 under consideration, wherein the respective relationships 118 can comprise one or more new relationships between entities as predicted by the model component 202 and/or AI component 204 using the embedding model. Based at least in part on the results of such analysis, the data modification component 208 and/or the AI component 204 can determine a group of candidate data modifications associated with the entity 116 under consideration, and can determine (e.g., calculate) respective probabilities that respective candidate data modifications of the group of candidate data modifications are the desired (e.g., correct, accurate, suitable, or optimal) candidate data modification to use to modify information associated with the entity 116 under consideration. In some embodiments, the data modification component 208 can determine (e.g., calculate) respective quality scores (e.g., ranking scores) associated with the respective candidate data modifications that can indicate the respective or relative qualities (e.g., respective or relative suitabilities) of the respective candidate data modifications based at least in part on the respective probabilities that the respective candidate data modifications of the group of candidate data modifications are the desired candidate data modification. In accordance with various embodiments, the data modification component 208 can determine the respective quality scores associated with the respective candidate data modifications to be or correspond (e.g., directly correspond) to the respective probabilities, or as a function of the respective probabilities (e.g., based on the respective probabilities and one or more other factors), that the respective candidate data modifications of the group of candidate data modifications are the desired candidate data modification. The ranking component 210 can rank the respective candidate data modifications associated with the entity 116 in order of highest probability or highest quality score to lowest probability or lowest quality score based at least in part on the respective probabilities or respective quality scores associated with the respective candidate data modifications.

The data modification component 208 can communicate data modification information (e.g., a candidate data modification list) regarding the group of candidate data modifications as an output to a decision component 212 of the DMC 102 and/or to a communication device 120 associated with a user 122 for consideration and evaluation by the decision component 212 and/or the user 122 (as indicated at reference numerals 312 and 314 of the data management process 300). The data modification information can comprise the respective candidate data modifications, respective probabilities (e.g., respective probability values) associated with the respective candidate data modifications, respective rankings associated with the respective candidate data modifications, and/or other desired information associated with the entity 116.

In some embodiments, the decision component 212 can evaluate the data modification information regarding the candidate data modifications to determine (e.g., automatically determine) which of the candidate data modifications (if any) can be the desired (e.g., correct, accurate, suitable, or optimal) candidate data modification to be selected to use to modify information associated with the entity 116. For instance, the decision component 212 can evaluate the data modification information regarding the candidate data modifications to determine whether any of the candidate data modifications (e.g., the highest ranked candidate data modification) have a probability that satisfies (e.g., meets or exceeds; or is greater than or equal to) a defined threshold probability or a quality score that satisfies a defined threshold quality score. If, based at least in part on the results of the evaluation, the decision component 212 determines that a probability or a quality score of a candidate data modification of the group of candidate data modifications satisfies the defined threshold probability or the defined threshold quality score, the decision component 212 can determine (e.g., automatically determine) that the candidate data modification can be the desired candidate data modification with respect to the entity 116 and can select (e.g., automatically select) the candidate data modification.

In response to selection of the desired candidate data modification, the data modification component 208 can modify the information of or associated with the entity 116 (e.g., new entity) under consideration based at least in part on the candidate data modification. For example, if the entity 116 comprises a field or cell in a table that contains a misspelled word (e.g., “Chiucago” instead of “Chicago”), the data modification component 208 can modify the information in the field or cell in the table to correct the misspelled word (e.g., correct the misspelled word to “Chicago”). As another example, if the entity 116 comprises a field or cell that is a column name in a table that contains an abbreviation or acronym (e.g., “CBA” in a table that contains customer names, addresses, and other customer information), the data modification component 208 can modify the information in or associated with the field or cell for the column name in the table to replace the abbreviation or acronym with the proper (e.g., correct or accurate) full column name (e.g., “customer billing address”) or associate the full name of the column with the field or cell, and/or the abbreviation or acronym. In the latter case, the abbreviation or acronym can remain displayed in the field or cell in the table, but the full column name can be presented (e.g., displayed) by hovering the cursor over the field or cell and/or by selecting (e.g., using buttons or controls of the mouse, trackpad, or keyboard to select) the field or cell to reveal the full column name. The decision component 212 also can communicate information relating to the selection of the candidate data modification and/or other feedback information relating thereto to the embedding model of the model component 202 (as indicated at reference numeral 316 of the data management process 300).

If, based at least in part on the results of the evaluation, the decision component 212 determines that none of the probabilities or quality scores associated with the candidate data modifications of the group of candidate data modifications satisfy the defined threshold probability or the defined threshold quality score, the decision component 212 can determine that it is not to select a candidate data modification with respect to the entity 116 and can determine that information relating to the group of candidate data modifications is to be forwarded (e.g., communicated) to the communication device 120 associated with the user 122 for evaluation by the user 122. In response, the DMC 102 (e.g., the model component 202, data modification component 208, decision component 212, or other component of the DMC 102) can communicate the information relating to the group of candidate data modifications associated with the entity 116 as an output to the communication device 120 (as indicated at reference numeral 312 of the data management process 300). In some embodiments, the disclosed subject matter can employ crowd sourcing to facilitate determining the desired candidate data modification (if any) to use for the entity 116, wherein the DMC 102 or the communication device 120 can communicate the information relating to the group of candidate data modifications associated with the entity 116 to desired communication devices associated with desired users to have such users evaluate the information relating to the group of candidate data modifications associated with the entity 116 and provide their selection of a desired candidate data modification or other feedback information regarding the group of candidate data modifications associated with the entity 116 to the DMC 102 and/or the communication device 120 associated with the user 122.

The user 122 and/or other users can evaluate the information relating to the group of candidate data modifications associated with the entity 116 (e.g., new entity) (as indicated at reference numeral 314 of the data management process 300). Based at least in part on the results of such evaluation, the user 122 and/or the other users can select the desired candidate data modification from the group of candidate data modifications associated with the entity 116. The user 122 can use the communication device 120, and/or the other users can use their communication devices, to communicate selection information indicating the selection of the desired candidate data modification and/or other feedback information relating to the entity 116 or the group of candidate data modifications to the model component 202 of the DMC 102 (as indicated at reference numeral 316 of the data management process 300). In response to the selection of the desired candidate data modification for the entity 116, the data modification component 208 can modify the information of or associated with the entity 116 (e.g., new entity) under consideration based at least in part on the candidate data modification, such as described herein.

In some embodiments, even if the decision component 212 selected a desired candidate data modification, the user 122 can (e.g., optionally can) review and evaluate the selection of the desired candidate data modification by the decision component 212 to determine whether the user 122 agrees that the candidate data modification selected by the decision component 212 is the correct candidate data modification to make for the entity 116. If the user 122 agrees with the selection of the candidate data modification by the decision component 212, the user 122, using communication device 120, can communicate feedback information to the embedding model that can indicate the user 122 agrees that the selection of the candidate data modification is the correct selection for the entity 116 (as indicated at reference numeral 316). If, based at least in part on the evaluation, the user 122 does not agree with the selection of the candidate data modification by the decision component 212, the user 122, using communication device 120, can override the selection and can select a different candidate data modification from the group of candidate data modifications with regard to the entity 116, and the user 122 can communicate the selection information and/or other feedback information to the embedding model (as indicated at reference numeral 316).

With further regard to the feedback, in response to the embedding model receiving the selection information and/or other feedback information from the user 122 (or other users) or the decision component 212, the model component 202, employing the embedding model, and/or the AI component 204 can analyze the selection information and/or other feedback information to facilitate determining whether any modifications (e.g., adjustments or changes) are to be made to the embedding model, the relationships 118 between entities 116 associated with the embedding model, and/or the weights associated with the entities 116 or relationships 118. For instance, if the decision component 212 or user 122 selected the highest ranking candidate data modification of the group of candidate data modifications with regard to an entity 116 (e.g., new entity), accordingly, based at least in part on the results of analyzing the selection information and/or other feedback information, the model component 202 and/or the AI component 204 can determine that the embedding model is desirably structured and no modification is to be made to the embedding model, the relationships 118 between entities 116, and/or the weights, when doing so is in accordance with the defined data management criteria. In some instances, alternatively, the model component 202 and/or the AI component 204 can determine that the embedding model, the relationships 118 between entities 116, and/or the weights are to be modified such that the probability or quality score associated with the selected and highest ranking candidate data modification with respect to future instances of the entity 116 (or similar entities) can be increased, and conversely, the probabilities or qualities scores associated with the other candidate data modifications of the group can be decreased, to reflect a higher probability, certainty, or confidence that the selected and highest ranking candidate data modification is the correct data modification to utilize for future instances of the entity 116 (or similar entities), when doing so is in accordance with the defined data management criteria.

If, instead, the user 122 selected a lower ranked candidate data modification of the group of candidate data modifications with regard to the entity 116 (e.g., new entity) (whether because the decision component 212 did not make a selection or because the user 122 overrode the selection made by the decision component 212), accordingly, based at least in part on the results of analyzing the selection information and/or other feedback information, the model component 202 and/or the AI component 204 can determine that the embedding model, the relationships 118 between entities 116, and/or the weights are to be modified such that the probability or quality score associated with the selected and lower ranking candidate data modification with respect to future instances of the entity 116 (or similar entities) can be increased, and conversely, the probabilities or qualities scores associated with the other candidate data modifications (including the highest ranked candidate data modification) of the group can be decreased, to reflect a higher probability, certainty, or confidence that the selected but lower ranked candidate data modification is the correct data modification to utilize for future instances of the entity 116 (or similar entities), when doing so is in accordance with the defined data management criteria. For example, in such instances, the model component 202 and/or the AI component 204 can determine that the embedding model, the relationships 118 between entities 116, and/or the weights are to be modified such that, in future instances of the entity 116 (or similar entities), the selected and previously lower ranked candidate data modification is to have the highest probability, highest quality score, and/or highest ranking relative to other candidate data modifications of the group of candidate data modifications, and the previously highest ranked candidate data modification is to have a lower probability, lower quality score, and/or lower ranking relative to the selected candidate data modification. The model component 202 can save and store any changes to the embedding model, the relationships 118 between entities 116, and/or the weights.

In some embodiments, the DMC 102 can comprise a version control component 214 that can store version information relating to the modifications to the information of or associated with the entities (e.g., data elements) in the data store 216 (e.g., in a version control system, repository, or database of the data store 216) (as indicated at reference numeral 318 of the data management process 300). The version control component 214 can store and maintain previous versions of changes to the information of or associated with the entities in the data store 216 to enable the DMC 102 or user 122 to access the previous versions of such changes, if and as desired, for example, for review or evaluation, or to facilitate determining a data modification to make with regard to a current instance of an entity.

The DMC 102 also can update the database (e.g., the table or other part of the database) to store the new data, such as the data modification made to the information of or associated with the entity 116 (e.g., new entity) and/or other information relating to the data modification, in the database (as indicated at reference numeral 320). For instance, for a new database 108 that was analyzed by the DMC 102, where a data modification was made to an entity 116 (e.g., new entity) of the new database 108, the DMC 102 can store the data modification and/or information relating thereto in the new database 108.

In some embodiments, to facilitate maintaining desirably high quality of the databases and data stored therein, the system 100 can comprise (e.g., optionally can comprise) a quality control component 124 that can be associated with (e.g., communicatively connected to) the DMC 102 and can monitor the evaluations and decisions made with regard to candidate data modifications by the DMC 102 or users (e.g., user 122) and/or other data of the databases. The quality control component 124 can evaluate and/or manage the quality of such evaluations and decisions by the DMC 102 or users to facilitate maintaining a desirably high quality level for data management, including the evaluations and decisions (e.g., automated decisions to update data) made with regard to candidate data modifications, by the DMC 102 or users (e.g., user 122) and a desirably high quality level of the databases and data stored therein.

For instance, the quality control component 124 can monitor updates (e.g., data modifications) made to the databases managed and updated by the DMC 102, including, in particular, automated updates made to the databases by the DMC 102, and the downstream effect of such data updates on applications, services, systems, other databases, and/or users that are utilizing the data, including the updated (e.g., modified) data, stored in the databases managed by the DMC 102. The quality control component 124 can evaluate such data updates and their downstream effect on the applications, services, systems, other databases, and/or users that are utilizing the data stored in the databases based at least in part on application of a set of performance indicators (e.g., key performance indicators (KPIs)) relating to database quality to such evaluation, wherein the set of performance indicators can comprise performance indicators relating to the correctness of the data, including updated data, in the databases managed by the DMC 102, and/or any errors, disruptions, or other negative effects resulting from use of the data, including the updated data, stored in the databases managed by the DMC 102 by the applications, services, systems, other databases, and/or users downstream from such databases managed by the DMC 102.

If, based at least in part on the results of such evaluation and application of the set of performance indicators, the quality control component 124 determines that no negative effects, or at least no threshold level of negative effects (e.g., no threshold number of data errors, or no threshold number of disruptions of operations), have been detected with regard to the data, including the updated data, stored in the databases managed by the DMC 102, the quality control component 124 can determine that the quality level for data management, including the evaluations and decisions (e.g., automated decisions to update data) made with regard to candidate data modifications, by the DMC 102 or users (e.g., user 122), is at a desirably high quality level. If, instead, based at least in part on the results of such evaluation and application of the set of performance indicators, the quality control component 124 determines that there are some negative effects (e.g., a threshold level of negative effects) that have been detected with regard to the data, including the updated data, stored in the databases managed by the DMC 102, the quality control component 124 can determine that the quality level for data management, including the evaluations and decisions (e.g., automated decisions to update data) made with regard to candidate data modifications, by the DMC 102 or users (e.g., user 122), is not achieving (e.g., is below) the desired high quality level, and can generate a quality control alert (e.g., quality control flag) and information relating to the quality control problems (e.g., data errors, disruptions, or other problems). For example, if, based at least in part on the results of such evaluation and application of the set of performance indicators, the quality control component 124 identifies that an application(s), service(s), system(s), other database(s), and/or user(s) utilizing the data (e.g., updated data) from the databases managed and updated by the DMC 102 is or are experiencing errors, disruptions (e.g., disruption in operations), or other negative effects as a result of utilizing such data (e.g., updated data), the quality control component 124 can determine that the quality level for data management by the DMC 102 or users (e.g., user 122) associated therewith, is not achieving the desired high quality level, and can generate a quality control alert regarding the quality control problems (e.g., the negative effects) and information relating thereto. The quality control component 124 can present (e.g., communicate) the quality control alert and the information relating to the quality control problems to a communication device(s) (e.g., communication device 120) or interface(s) associated with a user(s) (e.g., user 122) to notify the user(s) of the quality control problems associated with the data management by the DMC 102 so that the user(s) can perform further analysis or evaluation of the quality control problems to mitigate (e.g., rectify, minimize, and/or correct) the quality control problems.

In certain embodiments, the system 100 can comprise (e.g., optionally can comprise) a bias management component 126 that can be associated with (e.g., communicatively connected to) the DMC 102 and can detect, manage, mitigate, and/or facilitate mitigating bias, including ensuring fairness relating to bias with regard to attributes, that potentially may occur in the handling and processing of data (e.g., new and subsequently processed data) by the DMC 102 (e.g., by the models of the model component 202 or AI component 204), for example, due in part to biased data elements that are in the databases being managed by the DMC 102 and that are used to train the models of the model component 202. For instance, the data analyzed by the DMC 102 and used to train the models (e.g., information extraction model or embedding model) potentially can contain biased data elements, which can be biased (e.g., demographically biased) with regard to one or more attributes (e.g., demographic and/or sensitive attributes), and this potentially can introduce undesired (e.g., unwanted, improper, or unfair) bias into the operations and models of the DMC 102, which potentially can produce undesirable (e.g., unwanted, improper, or unfair) biased results (e.g., undesirable data modifications to data). The demographic and/or sensitive attributes can relate to, for example, income, wealth, home ownership, gender, age, marital status, family size or status, health and/or disability status, race, ethnicity, religion, sexual orientation, education status, employment status, geographical location status (e.g., location of home, location of person, location of employment, or other type of location), or other attributes that can be associated with persons.

The bias management component 126 can monitor and evaluate the data elements of the data analyzed by the DMC 102 and used to train the models of the DMC 102, data modifications proposed or made by the DMC 102, input information of users (e.g., user 122) with regard to the data modifications (e.g., accepting or selecting of highest ranked candidate data modifications, selecting lower ranked candidate data modifications over highest ranked candidate data modifications, or other comments relating to the data by the user(s)), or other desired (e.g., relevant) information. Based at least in part on such monitoring and evaluation, the bias management component 126 can detect, determine, or identify whether there is or at least potentially may be undesired bias in the data elements being processed by the DMC 102 or used to train the models of the DMC 102, and/or whether there is or at least potentially may be undesired bias being introduced into the operations or data modifications to data by the DMC 102 or associated models.

For instance, if, based at least in part on such monitoring and evaluation, the bias management component 126 determines that the DMC 102 and associated models are processing data, determining candidate data modifications, ranking candidate data modifications, and/or performing data modifications (e.g., automatically performing data modifications) in a desirable (e.g., appropriate, fair, unbiased, and/or optimal) manner with regard to various attributes, including demographic and/or sensitive attributes, based at least in part on the data elements of the databases being managed by the DMC 102, the new data under consideration, and the context associated with the new data, the bias management component 126 can determine that there is no undesired bias (e.g., no undesired bias detected), or at least no threshold level of bias, associated with the operations being performed by the DMC 102 and the data modifications being performed or proposed by the DMC 102. In such instance, the bias management component 126 can determine that no alert (e.g., bias alert or quality control alert) is to be generated.

If, instead, based at least in part on such monitoring and evaluation, the bias management component 126 determines that the DMC 102 and associated models are processing data, determining candidate data modifications, ranking candidate data modifications, and/or performing data modifications in an undesirable (e.g., inappropriate, unfair, or improperly biased) manner with regard to one or more of various attributes, which can include demographic and/or sensitive attributes, based at least in part on the data elements of the databases being managed by the DMC 102, the new data under consideration, and the context associated with the new data, the bias management component 126 can determine that there can or may be undesired bias, or can or may be a threshold level of bias, associated with the operations being performed by the DMC 102 and the data modifications being performed or proposed by the DMC 102. For example, if the bias management component 126 determines that the data elements processed and utilized by the DMC 102 (e.g., to train the models) is or potentially may be biased with regard to a demographic and/or sensitive attribute (e.g., age, gender, race, ethnicity, religion, or other attribute) and is or potentially may be introducing an undesired bias with regard to the demographic and/or sensitive attribute into training of the models, determining of candidate data modifications, ranking of candidate data modifications, selecting or performance (e.g., automatically selecting or performance) of data modifications, or performing of other operations of the DMC 102, the bias management component 126 can determine that there potentially can or may be undesired bias, or at least that there can or may be a threshold level of bias, associated with the operations being performed by the DMC 102 and the data modifications being performed or proposed by the DMC 102. As one non-limiting example, based at least in part on such monitoring and evaluation, the DMC 102 can or may determine that the DMC 102 or associated model has determined that a particular abbreviation means or likely means one particular term due at least in part to a bias or potential bias in the data elements, even if the context associated with new data comprising the particular abbreviation indicates that the particular abbreviation potentially may represent another term, and the DMC 102 or associated model is ranking the particular term as a higher candidate data modification than the other term, even though the context associated with the new data indicates that the particular abbreviation potentially may represent the other term. If an instance of bias or potential bias is detected by the bias management component 126, the bias management component 126 can determine that an alert (e.g., a bias alert or quality control alert) is to be generated to provide a notification of such bias or potential bias. In response, the bias management component 126 can generate the alert and can generate or aggregate information relating to the bias or potential bias, and can present (e.g., communicate) the alert and the information relating to the undesired bias or potential bias to a communication device(s) (e.g., communication device 120) or interface(s) associated with a user(s) (e.g., user 122) to notify the user(s) of the bias or potential bias associated with the data management by the DMC 102 so that the user(s) can perform further analysis or evaluation of the undesired bias or potential bias to mitigate (e.g., rectify, minimize, and/or correct) the undesired bias or potential bias, or other quality control problems relating thereto. Such monitoring and mitigating of bias or potential bias by the bias management component 126 can facilitate mitigating (e.g., reducing, minimizing, or eliminating) undesired bias in the data associated with the system 100 and can facilitate maintaining a desirably high quality level of the processing of data by the DMC 102 and a desirably high quality of the databases and data stored therein.

With further regard to FIGS. 1 and 2, in certain embodiments, the DMC 102 can comprise an alert component 218 that can generate alert or notification messages relating to evaluations of candidate data modifications and/or data modification decisions with regard to entities 116 made by the decision component 212, and can communication such alert or notification messages to a user(s), such as user 122 (e.g., via communication device 120), to inform or notify the user(s) of the evaluations of candidate data modifications and/or data modification decisions with regard to entities 116 made by the decision component 212, so that the user(s) can review such evaluations or decisions, if and as desired. The alert component 218 also can generate alert or notification messages relating to incorrect data modifications, false positives relating to data modification, and/or other anomalies relating to information stored in tables or databases, and can communicate the alert or notification messages to one or more users, such as the user 122 (e.g., to the communication device 120 associated with the user 122), and/or to another component (e.g., model component 202, AI component 204, or data modification component 208) of the DMC 102 to notify the user(s) 122 or component of the DMC 102 regarding the incorrect data modifications, the false positives relating to data modification, and/or the other anomalies. For instance, if new data (e.g., data of newly received tables or databases), such as new data that can pertain to a particular source or type (e.g., streaming data), is being received and analyzed by the DMC 102, and the DMC 102 is detecting an excessive amount (e.g., a threshold number or percentage) of problems relating to the new data, such as an excessive amount of incorrect data modifications, false positives relating to data modification, and/or other anomalies (e.g., excessive amount of data elements in the new data that are being determined to contain information that is to be modified by the DMC 102), the alert component 218 can generate an alert or notification message relating to such excessive amount of problems, and can communicate such alert or notification message to the user(s) 122 (e.g., via the communication device 120) or another component of the DMC 102. For instance, the DMC 102 can aggregate information regarding the problems relating to the new data and the source(s) of the new data, and the alert component 218 can include the aggregated information in the alert or notification message.

In some embodiments, if there is a significant number of alerts relating to problems or errors with data being generated, the DMC 102 (e.g., the model component 202, AI component 204, or alert component 218) can analyze information relating to the alerts (e.g., alert information or other relevant information) to determine whether there is a pattern to the alerts being generated. For instance, if there is a data stream that is delivering tables of data to the DMC 102, and if alerts are being generated with regard to same or similar kinds of data elements of the data stream, this may be an indication that there can be a quality issue with that data stream. The DMC 102 (e.g., the model component 202, AI component 204, or alert component 218) can analyze information relating to the alerts associated with that data stream and/or other relevant information to determine or infer whether there is a pattern to the alerts being generated for that data stream and/or information that can indicate what the quality issue is or may be. The alert component 218 can generate a particular kind of alert (e.g., a “super alert”) that can provide information (e.g., aggregated information) regarding the determinations or inferences relating to patterns and/or other information relating to the quality issue associated with the data stream. The alert component 218 can provide (e.g., communicate) the particular kind of alert and associated information (e.g., aggregated information) to a user (e.g., via the communication device 120 or interface associated with the user 122) for analysis by the user and/or to another component (e.g., AI component 204) of the DMC 102 for further analysis to facilitate rectifying or mitigating any quality issue associated with that data stream.

The DMC 102 also can comprise an operations manager component 220 that can control (e g, manage) operations associated with the DMC 102. For example, the operations manager component 220 can facilitate generating instructions to have components (e.g., model component 202, AI component 204, weight component 206, data modification component 208, ranking component 210, decision component 212, version control component 214, data store 216, alert component 218, and/or processor component 222) of or associated with the DMC 102 perform operations, and can communicate respective instructions to such respective components of or associated with the DMC 102 to facilitate performance of operations by the respective components of or associated with the DMC 102 based at least in part on the instructions, in accordance with the defined data management criteria and the defined data management algorithm(s) (e.g., data management algorithms, AI, machine learning, or neural network algorithms, and/or other algorithms, as disclosed, defined, recited, or indicated herein by the methods, systems, and techniques described herein). The operations manager component 220 also can facilitate controlling data flow between the respective components of the DMC 102 and controlling data flow between the DMC 102 and another component(s) or device(s) (e.g., devices or components, such as a communication device, a network device, or other component or device) associated with (e.g., connected to) the DMC 102.

The DMC 102 also can comprise a processor component 222 that can work in conjunction with the other components (e.g., model component 202, AI component 204, weight component 206, data modification component 208, ranking component 210, decision component 212, version control component 214, data store 216, alert component 218, and/or operations manager component 220) to facilitate performing the various functions of the DMC 102. The processor component 222 can employ one or more processors, microprocessors, or controllers that can process data, such as information relating to electronic documents, tables, databases, data elements, entities, relationships between entities, metadata, character recognition, information extraction models, embedding models, data modifications, alerts, notifications, communication devices, policies and rules, users, services, defined data management criteria, traffic flows, signaling, algorithms (e.g., data management algorithms, AI, machine learning, or neural network algorithms, and/or other algorithms), protocols, interfaces, tools, and/or other information, to facilitate operation of the DMC 102, as more fully disclosed herein, and control data flow between the DMC 102 and other components (e.g., network components of or associated with the communication network, or communication devices) and/or associated applications associated with the DMC 102.

With further regard to the data store 216, the data store 216 can store data structures (e.g., user data, metadata), code structure(s) (e.g., modules, objects, hashes, classes, procedures) or instructions, information relating to electronic documents, tables, databases, data elements, entities, relationships between entities, metadata, character recognition, information extraction models, embedding models, data modifications, alerts, notifications, communication devices, policies and rules, users, services, defined data management criteria, traffic flows, signaling, algorithms (e.g., data management algorithms, AI, machine learning, or neural network algorithms, and/or other algorithms), protocols, interfaces, tools, and/or other information, to facilitate controlling operations associated with the DMC 102. In an aspect, the processor component 222 can be functionally coupled (e.g., through a memory bus) to the data store 216 in order to store and retrieve information desired to operate and/or confer functionality, at least in part, to the DMC 102 and its components, and the data store 216, and/or substantially any other operational aspects of the DMC 102.

It should be appreciated that the data store 216 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

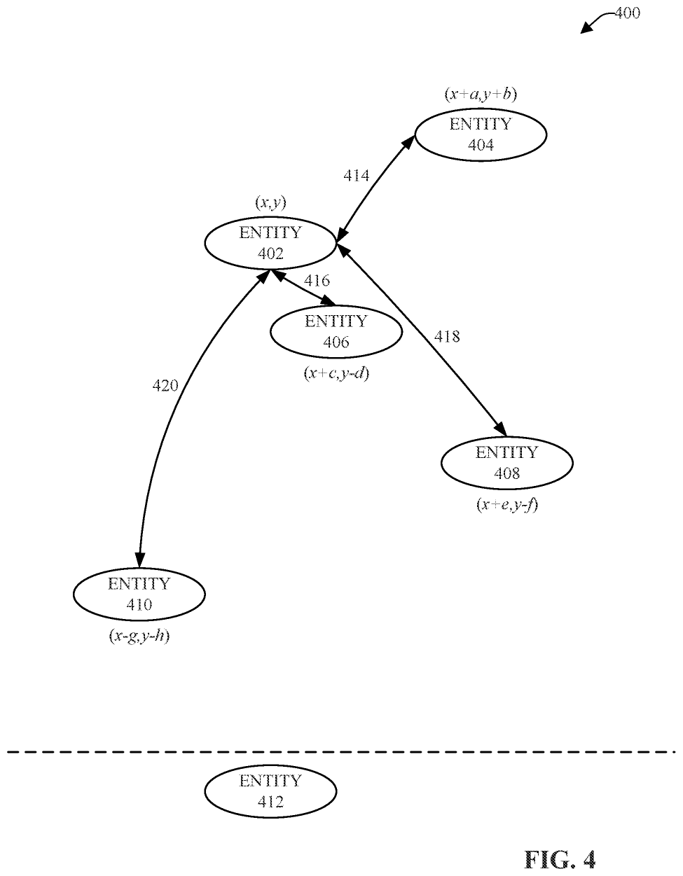

Referring now to FIG. 4 (along with FIGS. 1-3), FIG. 4 depicts a diagram of an example, non-limiting entity relationship mapping 400, in accordance with various aspects and embodiments of the disclosed subject matter. In some embodiments, the model component 202 and/or AI component 204 can generate entity relationship mappings, such as the example entity relationship mapping 400, to map respective relationships between respective entities associated with electronic documents, tables, or databases. For instance, based at least in part on the results of analyzing (e.g., performing an AI analysis on) electronic documents (e.g., 104), tables (e.g., 106), or databases (e.g., 108), information from other data sources (e.g., data dictionaries 110, metadata 112, or external information 114), and/or auxiliary information (e.g., entity weights or relationship weights), the model component 202 and/or AI component 204 can determine respective relationships between respective entities of or associated with the electronic documents, tables, or databases, and/or the auxiliary information, and can map structured or unstructured information relating to the entities and the relationships to the desired common representation (e.g., a desired common structured format) to generate, for example, the entity relationship mapping 400 and/or other entity relationship mappings.

With regard to the example entity relationship mapping 400, based at least in part on the results of such analysis, the model component 202 and/or AI component 204 can determine that the entity 402 can have various relationships with other entities, including entity 404, entity 406, entity 408, and entity 410, and also can determine that the entity 402 does not have a relationship with certain other entities, such as entity 412. For instance, the entity 402 can have a relationship 414 with the entity 404, a relationship 416 with the entity 406, a relationship 418 with the entity 408, and a relationship 420 with the entity 410. Also, based at least in part on the results of such analysis (e.g., AI analysis using one or more AI techniques or algorithms, such as described herein), the model component 202 and/or AI component 204 can map structured or unstructured information relating to the entities (e.g., 404, 406, 408, and 410) and the relationships (e.g., 414, 416, 418, and 420) to the desired common representation to generate the entity relationship mapping 400. Based on such analysis results, and as part of the mapping and structuring of the respective entities and respective relationships to the desired common representation, the model component 202 and/or AI component 204 can determine (e.g., calculate) respective numerical values that can represent the entities (e.g., 404, 406, 408, and 410) and the respective relationships between entities (e.g., 414, 416, 418, and 420) in relation to each other. For example, in the entity relationship mapping 400, the entity 402 can be located at a particular point (x,y) on the mapping 400, and, in relation to the entity 402, the entity 404 can be located at (x+a, y+b), the entity 406 can be located at (x+c, y−d), the entity 408 can be located at (x+e, y−f), and the entity 410 can be located at (x−g, y−h), wherein x, y, a, b, c, d, e, f, g, and h can represent respective numerical values (e.g., respective real numbers). An entity that is relatively close in distance from the entity 402 can have a relatively stronger relationship to the entity 402 than an entity that is relatively further in distance away from the entity 402. For instance, as can be observed in the entity relationship mapping 400, the entity 406 can have the strongest relationship (e.g., relationship 416) with the entity 402 because the entity 406 is closest to the entity 402, the entity 404 also can have a relatively strong relationship (e.g., relationship 414) with the entity 402 because it is relatively close to the entity 402, although not as close as entity 406, and the entity 408 and entity 410 can have relatively weaker relationships (e.g., relationship 418, relationship 420) with the entity 402 because they are located further away from the entity 402 than entity 404 and entity 406.

Also, based on such analysis results, the model component 202 and/or AI component 204 can determine that the entity 412 does not have a relationship with the entity 402. For instance, if the entity 402 relates to a time-of-day value, and the model component 202 and/or AI component 204 determine that the entity 412 contains or is associated with a negative numerical value or an alphabetical textual string that does not represent a time value, and determines that there is no other type of relationship that can be between the entity 402 and entity 412 and the entity 412 does not provide any context to the entity 412, the model component 202 and/or AI component 204 can determine that the entity 412 does not have a relationship with the entity 402, because the entity 402 relates to a time-of-day value and a time-of-day value cannot have a negative numerical value and would not have an alphabetical textual string that does not represent a time value.

The model component 202 and/or AI component 204 can input the information relating to the entity relationship mapping 400, including the respective numerical values (e.g., the respective x,y coordinates) associated with the respective entities (e.g., 404, 406, 408, and 410), the respective relationships between the respective entities (e.g., 414, 416, 418, and 420), and/or other desired information (e.g., type of entity, type of relationship, or other contextual information) to the embedding model (e.g., the AI-based embedding model) for further analysis by the embedding model (e.g., by the AI component 204) to determines one or more candidate data modifications associated with the entity 402. Since the entity 406 has a relatively closer relationship (e.g., 416) to the entity 402 than the relationship (e.g., 420) between the entity 410 and entity 402, the entity 406 and information of or relating thereto typically can have more of an influence on the determination of the one or more candidate data modifications associated with the entity 402 than the entity 410 and information of or relating to the entity 410.

It is to be appreciated and understood that, for reasons of brevity and clarity, the example entity relationship mapping 400 presented certain relationships between the entity 402 and other entities (e.g., 404, 406, 408, and 410) and from the perspective of the entity 402. However, there also may be other relationships between the entity 402 and various other entities (not shown in FIG. 4) or other relationships between the other entities (e.g., with each other).

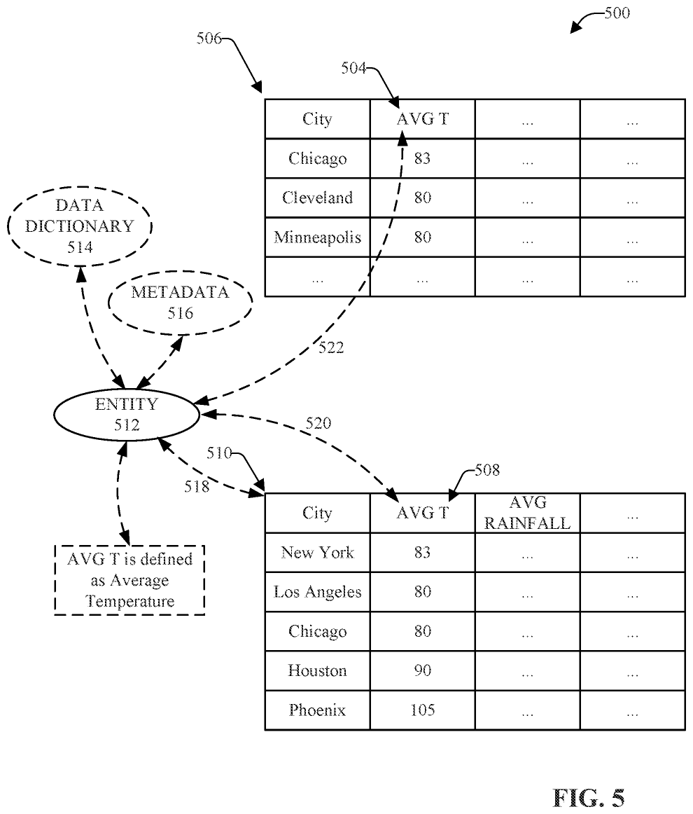

Turning to FIG. 5 (along with FIGS. 1-3), FIG. 5 illustrates a diagram of example, non-limiting entity relationships 500, in accordance with various aspects and embodiments of the disclosed subject matter. The example entity relationships 500 can comprise a relationship 502 between an entity 504 in a first table 506 and an entity 508 in a second table 510, wherein it can be desired to determine a data modification for the entity 504. For instance, the entity 504 can be a column name AVG T in the table 506, which can relate to various features, including weather and climate conditions (e.g., during the summer), of various cities in the United States. The table 510 can comprise the entity 508, which also can have a column name AVG T, wherein the table 510 can relate to weather and climate conditions (e.g., during the summer) of highly populated cities (e.g., New York, Los Angeles, Chicago, Houston, Phoenix) in the United States. The table 510 also can have an entity 512, which can define AVG T as meaning “Average Temperature,” wherein the entity 512 can be associated with a data dictionary 514 or metadata 516 associated with the table 510. The entity 512 can have a relationship 518 with the table 510 (which also can be an entity) and relationship 520 with the entity 508.

The model component 202 and/or AI component 204 can analyze various databases and tables, including tables 506 and 510, and other information, including the data dictionary 514 or metadata 516. Based at least in part on the results of analyzing the various databases, tables, and other information, the model component 202 and/or AI component 204 can identify the entities (e.g., entity 504, first table 506, entity 508, second table 510, entity 512, data dictionary 514, and/or metadata 516), and relationships between entities, including relationship 502 between the entity 504 and the entity 508, the relationship 518 between the entity 512 and the second table 510, and the relationship 520 between the entity 512 and the entity 508. The model component 202 and/or AI component 204 also can or may determine that there is a relationship 522 between the entity 504 and the entity 512, given the relationship 502 between the entity 504 and the entity 508 and the relationship 520 between the entity 512 and the entity 508. The model component 202 and/or AI component 204 can embed such various entities and relationships to create an embedding model, as more fully described herein.

Based at least in part on the analysis results and the analysis of the embedding model, the model component 202 and/or AI component 204 can determine that the data dictionary 514 or metadata 516 defines AVG T of the entity 512 as “Average Temperature,” and/or also can determine that the entity 504 contains the same abbreviation AVG T that the entity 508 contains (e.g., based in part on the relationship 502). Based at least in part on the relationship 502 between the entity 504 and the entity 508 and/or the relationship 520 between the entity 512 and the entity 508, and the definition of AVG T of the entity 512 as “Average Temperature,” as provided in or indicated by the embedding model, the model component 202 and/or AI component 204 can determine that one of the candidate data modifications to be considered for the entity 504 can be that the entity 504 can be modified to replace AVG T with “Average Temperature” or to associate “Average Temperature” with AVG T for the entity 504. The model component 202 likely also can determine that such candidate data modification is the highest ranking candidate data modification relative to any other candidate data modification (e.g., if doing so is in accordance with the defined data management criteria and there is no other candidate data modification that appears to be a better (e.g., more accurate) modification).

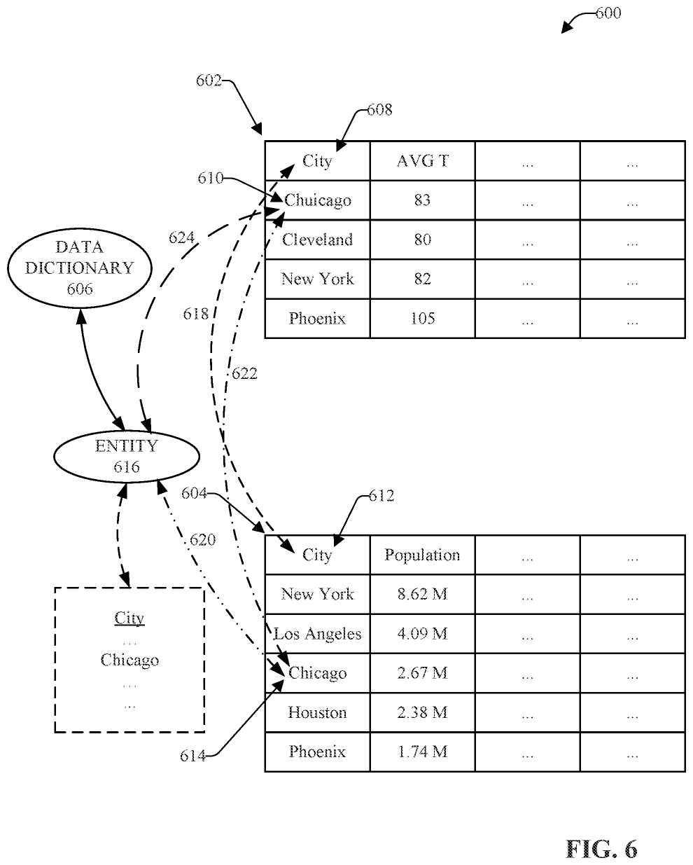

Referring to FIG. 6 (along with FIGS. 1-3), FIG. 6 depicts a diagram of other example, non-limiting entity relationships 600, in accordance with various aspects and embodiments of the disclosed subject matter. There can be a table 602 relating to average temperatures (AVG T) of various larger cities in the United States, and a table 604 that can comprise information relating to respective populations of larger cities in the United States, as well as other tables and databases. There also can be a data dictionary 606, which can be a dictionary from a third-party data source and not directly associated with the table 602 or table 604, or, alternatively, can be associated with the table 604.

The model component 202 and/or AI component 204 can analyze various databases and tables, including tables 602 and 604, and other information, including the data dictionary 606. Based at least in part on the results of analyzing the various databases, tables, and other information, the model component 202 and/or AI component 204 can identify various entities, including, for example, entity 608 (column name “City”), entity 610 (“Chuicago”), entity 612 (column name “City”), entity 614 (“Chicago”), and entity 616 (“Chicago” under a listing of cities in the United States) as contained in the data dictionary 606, as well as other entities, such as table 602, table 604, and data dictionary 606. Also, based at least in part on the results of analyzing the various databases, tables, and other information, the model component 202 and/or AI component 204 can identify various relationships between various entities, including relationship 618 between entity 608 (“City”) and entity 612 (“City”) (e.g., based in part on having the same column names), relationship 620 between the entity 614 (“Chicago”) in table 604 and the entity 616 (“Chicago” under a listing of cities in the United States) in the data dictionary 606 (e.g., based in part on each textual strong being the same (e.g., “Chicago”)), relationship 622 between the entity 614 (“Chicago”) in table 604 and the entity 610 (“Chuicago”) in table 602 (e.g., based in part on the textual string of “Chicago” being substantially similar to the textual string of “Chuicago”), and/or relationship 624 between the entity 616 (“Chicago”) in the data dictionary 606 and the entity 610 (“Chuicago”) in table 602 (e.g., based in part on the textual string of “Chicago” being substantially similar to the textual string of “Chuicago”). The model component 202 and/or AI component 204 can embed such various entities and relationships to create an embedding model, as more fully described herein.

Based at least in part on the analysis results and the analysis of the embedding model, the model component 202 and/or AI component 204 can determine that the data dictionary 606 comprises a listing of cities, including entity 616 (city of “Chicago”), and can determine a relationship 620 between entity 616 and entity 614 (“Chicago”) in table 604 and a relationship 622 between entity 614 (“Chicago”) in table 604 and entity 610 (“Chuicago”) in table 602 (e.g., due in part to both entity 610 and entity 614 respectively being in columns named “City” (e.g., relationship 618) and due in part to the textual string of “Chicago” being substantially similar to the textual string of “Chuicago”) and/or a relationship 620 between entity 616 (“Chicago”) in data dictionary 606 and entity 610 (“Chuicago”) in table 602 (e.g., an indirect relationship due in part to the relationship 620 between entity 616 and entity 614).

Based at least in part on the data dictionary 606 comprising a listing of cities, including the entity 616 (city of “Chicago” with such spelling), and the respective relationships, including the relationship 618, the relationship 620, the relationship 622, and/or the relationship 624, as provided or indicated in the embedding model, the model component 202 and/or AI component 204 can determine that one of the candidate data modifications to be considered for the entity 610 can be that the entity 610 can be modified to replace the textual string “Chuicago” with the textual string “Chicago” (e.g., the correct spelling of the city of Chicago). The model component 202 likely also can determine that such candidate data modification is the highest ranking candidate data modification relative to any other candidate data modification (e.g., if doing so is in accordance with the defined data management criteria and there is no other candidate data modification that appears to be a better (e.g., more accurate) modification).

As another non-limiting example, the model component 202 and/or AI component 204 can analyze electronic documents (e.g., 104) tables (e.g., 106), databases (e.g., 108), other information from other data sources (e.g., data dictionaries 110, metadata 112, or external information 114), and/or auxiliary information (e.g., entity weights or relationship weights) to determine or disambiguate (e.g., decrypt, interpret, or explain) an acronym or abbreviation, such as “CBA” in a column of a table. “CBA” can be an acronym or abbreviation for various words, such as, for example, “customer billing address”, “customer billing account”, “call barring access”, or some other type of name or phrase, depending in part on the context in which “CBA” is used. If, for example, “CBA” is used as a column name in a table that includes data entries in cells in that column that are textual strings representing (e.g., that correspond to) street addresses and/or another column of such table comprises textual strings representing other information associated with customers and/or other information (e.g., another instance of “CBA” in another table (e.g., 106), a data dictionary 110, metadata 112, or external information 114) indicates that “CBA” can mean “customer billing address”, the model component 202 and/or AI component 204 can determine respective entities, respective relationships between respective entities, and/or a context for “CBA” as the column name of the table, based at least in part on an analysis, including analysis relating to “CBA,” of information in or associated with the electronic documents 104, tables 106, databases 108, and/or other information (e.g., data dictionary 110, metadata 112, or external information 114) and the creation of the embedding model, as more fully described herein. The entities and relationships determined by the model component 202 and/or AI component 204 can comprise, for example, a relationship(s) (e.g., relatively stronger or higher quality relationship(s)) between column name “CBA” and the textual strings identified as representing street addresses in the table, and a relationship (e.g., a relatively stronger or higher quality relationship) between the column name “CBA” in the table and another instance of “CBA” in another table or data source, wherein the other instance of “CBA” in the other table or data source is defined or represented as “customer billing address.” From the analysis and the embedding model, the model component 202 and/or AI component 204 also can identify relatively weaker relationships that can indicate “CBA” as the column name of the table potentially may be “customer billing account” or “call barring access”.

In this example instance, based at least in part on the analysis results, including the identified entities and relationships, and the embedding model that can be created in part from such analysis results, which can include contextual information regarding the context of the use of “CBA” as the column name in that table, the model component 202 and/or AI component 204 can determine that “CBA” can represent “customer billing address” based at least in part on the relatively stronger relationships (and associated context), including that “CBA” is a column name for associated data entries (e.g., associated entities) that represent street addresses (and thus can be customer billing addresses of customers) and/or another instance of “CBA” in another table or a data source associated with that other table that defines “CBA” as “customer billing address.” Accordingly, the data modification component 208 can determine that the group of candidate data modifications can comprise “customer billing address” as a candidate data modification, and such candidate data modification of “customer billing address” can be the highest ranked candidate data modification of that group, although the group of candidate data modifications also may include “customer billing account” and/or “call barring access” as lower ranked (and correspondingly lower probability) candidate data modifications.

If, instead, “CBA” had been used as a column name in the table that includes data entries in cells in that column that are numerical textual strings, rather that alphanumeric textual strings that can correspond to street addresses, and/or another column of such table comprised textual strings that can represent other information associated with customers and/or other information (e.g., another instance of “CBA” in another table (e.g., 106), a data dictionary 110, metadata 112, or external information 114) indicates that “CBA” can mean “customer billing account”, the model component 202 and/or AI component 204 can determine respective entities, respective relationships between respective entities, and/or a context for “CBA” as the column name of the table, based at least in part on an analysis, including analysis relating to “CBA,” of information in or associated with the electronic documents 104, tables 106, databases 108, and/or other information (e.g., data dictionary 110, metadata 112, or external information 114) and the creation of the embedding model, as more fully described herein. The entities and relationships determined by the model component 202 and/or AI component 204 can comprise, for example, a relationship(s) (e.g., relatively stronger or higher quality relationship(s)) between column name “CBA” and the textual strings identified as being numerical textual strings (e.g., which can be customer billing account numbers, as opposed to street addresses that can include street names) in the table, and a relationship (e.g., a relatively stronger or higher quality relationship) between the column name “CBA” in the table and another instance of “CBA” in another table or data source, wherein the other instance of “CBA” in the other table or data source is defined or represented as “customer billing account.” From the analysis and the embedding model, the model component 202 and/or AI component 204 also can identify relatively weaker relationships that can indicate “CBA” as the column name of the table potentially may be “customer billing address” or “call barring access”.

In this other example instance, based at least in part on the analysis results, including the identified entities and relationships, and the embedding model that can be created in part from such analysis results, which can include contextual information regarding the context of the use of “CBA” as the column name in that table, the model component 202 and/or AI component 204 can determine that “CBA” can represent “customer billing account” based at least in part on the relatively stronger relationships (and associated context), including that “CBA” is a column name for associated data entries (e.g., associated entities) that can be numerical textual strings (and thus can more likely represent customer billing account numbers of customers, as opposed to customer billing addresses of customers) and/or another instance of “CBA” in another table or a data source associated with that other table that defines “CBA” as “customer billing account.” Accordingly, the data modification component 208 can determine that the group of candidate data modifications can comprise “customer billing account” as a candidate data modification, and such candidate data modification of “customer billing account” can be the highest ranked candidate data modification of that group, although the group of candidate data modifications also may include “customer billing address” and/or “call barring access” as lower ranked (and correspondingly lower probability) candidate data modifications.

In accordance with various embodiments, the disclosed subject matter, employing the DMC 102 and its constituent or associated components, and/or associated applications, can perform multiple (e.g., two or more) operations relating to analysis of electronic documents, tables, or databases, extraction of information from electronic documents, tables, or databases, embedding of entities and relationships between entities, creation or updating of models (e.g., information extraction model, embedding model), prediction of relationships between entities, character recognition, determination of candidate data modifications, modification of information of or associated with an entity or entities, evaluation of candidate data modifications, and/or other operations, in parallel, concurrently, and/or simultaneously, as desired.

With further regard to the communication device (e.g., communication device 120), a communication device also can be referred to as, for example, a device, a mobile device, or a mobile communication device. The term “communication device” can be interchangeable with (or include) user equipment (UE) or other terminology. A communication device (or UE or device) can refer to any type of wireless device that can communicate with a radio network node in a cellular or mobile communication system of a communication network, or can refer to any device that can be connected to a communication network via a wireline communication connection. Examples of communication devices can include, but are not limited to, a cellular and/or smart phone, a mobile terminal, a scanner or multi-purpose printer/scanner device, a computer (e.g., a laptop embedded equipment (LEE), a laptop mounted equipment (LME), or other type of computer), a device to device (D2D) UE, a machine type UE or a UE capable of machine to machine (M2M) communication, a Personal Digital Assistant (PDA), a tablet or pad (e.g., an electronic tablet or pad), a smart meter (e.g., a smart utility meter), an electronic gaming device, electronic eyeglasses, headwear, or bodywear (e.g., electronic eyeglasses, headwear, or bodywear having wireless communication functionality), an appliance (e.g., a toaster, a coffee maker, a refrigerator, or an oven having wireless communication functionality), a device associated or integrated with a vehicle (e.g., automobile, airplane, bus, train, or ship), a drone having wireless communication functionality, a home or building automation device (e.g., security device, climate control device, lighting control device), an industrial or manufacturing related device, and/or any other type of communication devices (e.g., other types of Internet of Things (IoTs)).

The AI component 204 can employ artificial intelligence techniques and algorithms, and/or machine learning techniques and algorithms, to facilitate determining or inferring users (e.g., social contacts) associated with a recipient user that are to be selected to invite to participate in a pool associated with the recipient user in connection with an event, determining or inferring merchants associated with a recipient user that are to be selected to invite to participate in a pool associated with the recipient user in connection with an event, determining or inferring a gift item (e.g., gift for a good or service associated with a merchant, or a gift in the form of an offer or discount for a good or service provided by a merchant) that can be selected, purchased, or recommended with regard to a pool associated with the recipient user in connection with an event, and/or automating one or more functions or features of the disclosed subject matter, as more fully described herein.

With further regard to the AI component 204, the AI component 204 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 204 can examine the entirety or a subset of the data (e.g., datasets, such as datasets stored in tables 106 or databases 108, data in electronic documents 104, data in data dictionaries 110, metadata 112, external information 114, or other data) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f (z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

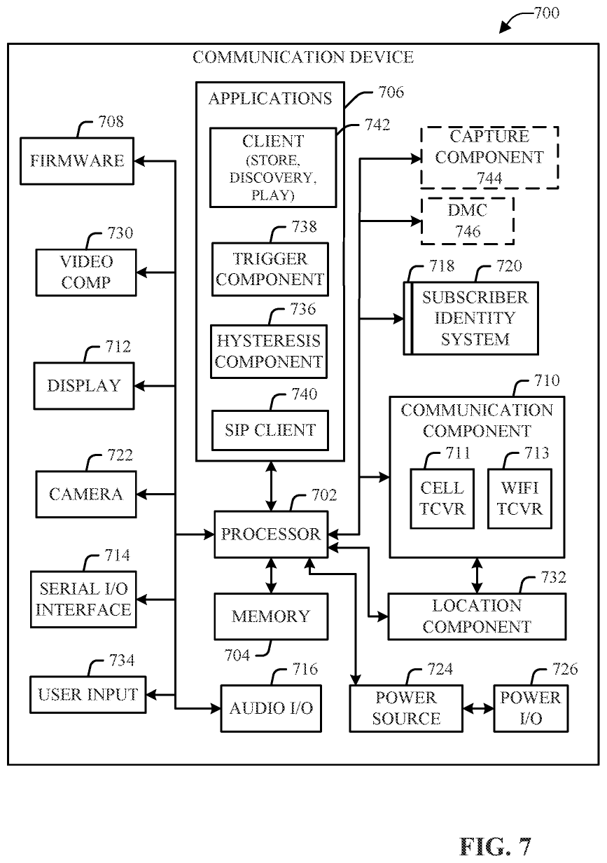

Referring now to FIG. 7, FIG. 7 depicts an example block diagram of an example communication device 700 (e.g., wireless or mobile phone, electronic pad or tablet, or IoT device) operable to engage in a system architecture that facilitates wireless communications according to one or more embodiments described herein. Although a communication device is illustrated herein, it will be understood that other devices can be a communication device, and that the communication device is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software. Also, while, in some embodiments, the communication device 700 can be a wireless communication device, in other embodiments of the disclosed subject matter, a communication device can communicate via a wireline communication connection with a communication network.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The communication device 700 can include a processor 702 for controlling and processing all onboard operations and functions. A memory 704 interfaces to the processor 702 for storage of data and one or more applications 706 (e.g., a video player software, user feedback component software, or other application). Other applications can include voice recognition of predetermined voice commands that facilitate initiation of the user feedback signals. The applications 706 can be stored in the memory 704 and/or in a firmware 708, and executed by the processor 702 from either or both the memory 704 or/and the firmware 708. The firmware 708 can also store startup code for execution in initializing the communication device 700. A communication component 710 interfaces to the processor 702 to facilitate wired/wireless communication with external systems, e.g., cellular networks, VoIP networks, and so on. Here, the communication component 710 can also include a suitable cellular transceiver 711 (e.g., a GSM transceiver) and/or an unlicensed transceiver 713 (e.g., Wi-Fi, WiMax) for corresponding signal communications. The communication device 700 can be a device such as a cellular telephone, a PDA with mobile communications capabilities, and messaging-centric devices. The communication component 710 also facilitates communications reception from terrestrial radio networks (e.g., broadcast), digital satellite radio networks, and Internet-based radio services networks.

The communication device 700 includes a display 712 for displaying text, images, video, telephony functions (e.g., a Caller ID function), setup functions, and for user input. For example, the display 712 can also be referred to as a “screen” that can accommodate the presentation of multimedia content (e.g., music metadata, messages, wallpaper, graphics, etc.). The display 712 can also display videos and can facilitate the generation, editing and sharing of video quotes. A serial I/O interface 714 is provided in communication with the processor 702 to facilitate wired and/or wireless serial communications (e.g., USB, and/or IEEE 1394) through a hardwire connection, and other serial input devices (e.g., a keyboard, keypad, and mouse). This supports updating and troubleshooting the communication device 700, for example. Audio capabilities are provided with an audio I/O component 716, which can include a speaker for the output of audio signals related to, for example, indication that the user pressed the proper key or key combination to initiate the user feedback signal. The audio I/O component 716 also facilitates the input of audio signals through a microphone to record data and/or telephony voice data, and for inputting voice signals for telephone conversations.

The communication device 700 can include a slot interface 718 for accommodating a SIC (Subscriber Identity Component) in the form factor of a card Subscriber Identity Module (SIM) or universal SIM 720, and interfacing the SIM card 720 with the processor 702. However, it is to be appreciated that the SIM card 720 can be manufactured into the communication device 700, and updated by downloading data and software.

The communication device 700 can process IP data traffic through the communication component 710 to accommodate IP traffic from an IP network such as, for example, the Internet, a corporate intranet, a home network, a person area network, etc., through an ISP or broadband cable provider. Thus, VoIP traffic can be utilized by the communication device 700 and IP-based multimedia content can be received in either an encoded or a decoded format.

A video processing component 722 (e.g., a camera) can be provided for decoding encoded multimedia content. The video processing component 722 can aid in facilitating the generation, editing, and sharing of video quotes. The communication device 700 also includes a power source 724 in the form of batteries and/or an AC power subsystem, which power source 724 can interface to an external power system or charging equipment (not shown) by a power I/O component 726.

The communication device 700 can also include a video component 730 for processing video content received and, for recording and transmitting video content. For example, the video component 730 can facilitate the generation, editing and sharing of video quotes. A location tracking component 732 facilitates geographically locating the communication device 700. As described hereinabove, this can occur when the user initiates the feedback signal automatically or manually. A user input component 734 facilitates the user initiating the quality feedback signal. The user input component 734 can also facilitate the generation, editing and sharing of video quotes. The user input component 734 can include such conventional input device technologies such as a keypad, keyboard, mouse, stylus pen, and/or touch screen, for example.

Referring again to the applications 706, a hysteresis component 736 facilitates the analysis and processing of hysteresis data, which is utilized to determine when to associate with the access point. A software trigger component 738 can be provided that facilitates triggering of the hysteresis component 736 when the Wi-Fi transceiver 713 detects the beacon of the access point. A SIP client 740 enables the communication device 700 to support SIP protocols and register the subscriber with the SIP registrar server. The applications 706 can also include a client 742 that provides at least the capability of discovery, play and store of multimedia content, for example, music.

The communication device 700, as indicated above related to the communication component 710, includes an indoor network radio transceiver 713 (e.g., Wi-Fi transceiver). This function supports the indoor radio link, such as IEEE 802.11, for the dual-mode GSM device (e.g., communication device 700). The communication device 700 can accommodate at least satellite radio services through a device (e.g., handset device) that can combine wireless voice and digital radio chipsets into a single device (e.g., single handheld device).

In some embodiments, the communication device 700 optionally can comprise a capture component 744 that can comprise or employ a camera or scanner to capture or scan physical documents or images, including physical documents or images that can comprise tables, which can include cells or fields that contain items of data, as more fully described herein. For example, the capture component 744 can capture (e.g., capture an image of) a physical document comprising a table that contains a group of cells or fields that comprise items of data, as more fully described herein.

In certain embodiments, the communication device 700 optionally can comprise a DMC 746 that can perform various operations relating to analysis of electronic documents, tables, or databases, extraction of information from electronic documents, tables, or databases, embedding of entities and relationships between entities, creation or updating of models (e.g., information extraction model, embedding model), prediction of relationships between entities, character recognition, determination of candidate data modifications, modification of information of or associated with an entity or entities, evaluation of candidate data modifications, and/or other operations, in accordance with the data management criteria, as more fully described herein.

The systems and/or devices have been (or will be) described herein with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

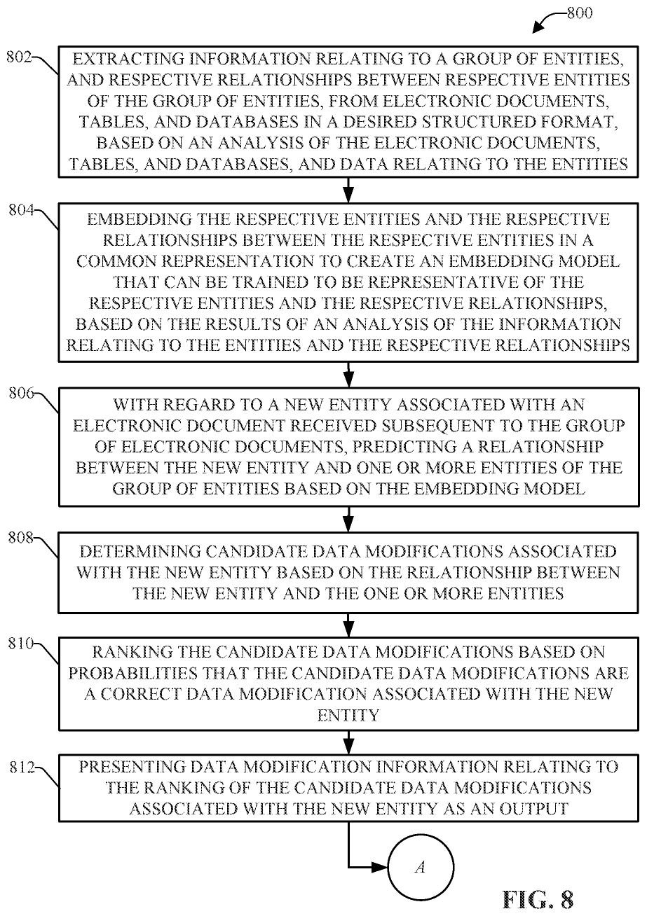

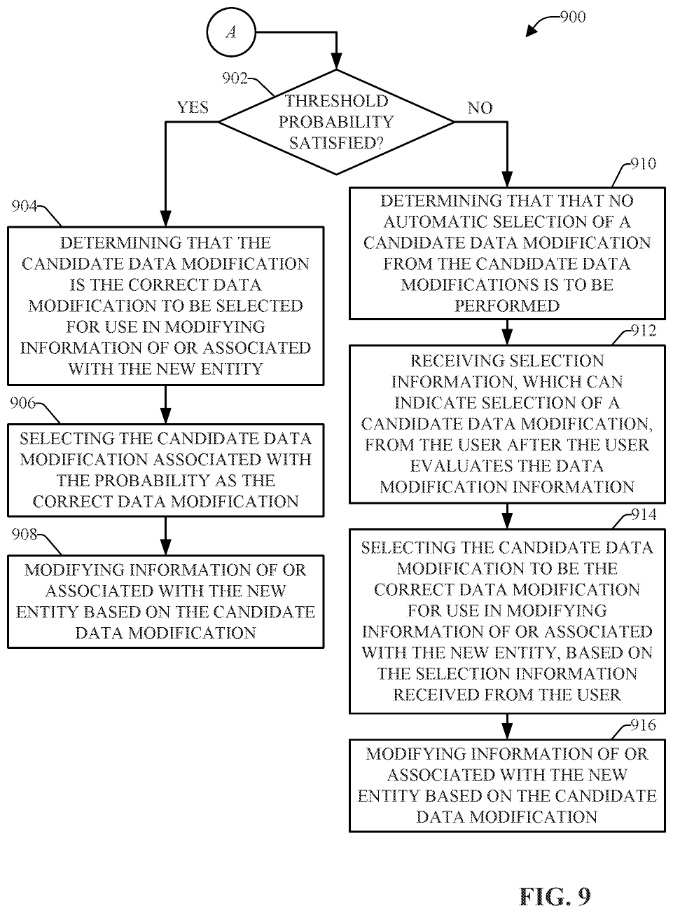

In view of the example systems and/or devices described herein, example methods that can be implemented in accordance with the disclosed subject matter can be further appreciated with reference to flowchart in FIGS. 8-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow diagram of an example, non-limiting method 800 that can desirably (e.g., accurately and efficiently) determine, modify, correct, and organize data elements of documents (e.g., electronic documents), tables, and databases, in accordance with various aspects and embodiments of the disclosed subject matter. The method 800 can be implemented by a system that can comprise a DMC, a processor component, a data store, and/or another component(s). Alternatively, or additionally, a machine-readable medium can comprise executable instructions that, when executed by a processor, facilitate performance of the operations of the method 800.

At 802, information relating to a group of entities, and respective relationships between respective entities of the group of entities, can be extracted from electronic documents, tables, and databases in a desired structured format, based at least in part on an analysis of the electronic documents, tables, and databases, and entity-related information relating to the entities. The DMC can analyze the electronic documents, tables, and databases. In some embodiments, the DMC also can analyze entity-related information relating to the entities. The entity-related information relating to the entities can comprise, for example, data dictionaries or metadata associated with tables or databases, and/or external information, such as more fully described herein. Based at least in part on the results of the analysis, the DMC, employing an information extraction model, can extract information relating to respective entities of the group of entities and respective relationships between the respective entities from the electronic documents, tables, databases, and/or the entity-related information relating to the entities. The DMC can incorporate the extracted information into the information extraction model.

At 804, the respective entities and the respective relationships between the respective entities can be embedded in a common representation to create an embedding model that can be trained to be representative of the respective entities and the respective relationships between the respective entities, based at least in part on the results of an analysis of the information relating to the entities and the respective relationships between the respective entities and/or the entity-related information. The DMC can embed the respective entities and the respective relationships between the respective entities in the embedding model in the common representation (e.g., a desired common structured format), based at least in part on the results of the analysis of the information relating to the entities and the respective relationships between the respective entities and/or the entity-related information, as more fully described herein. In some embodiments, the DMC can employ the AI component to perform an AI analysis on the information relating to the respective entities and the respective relationships between the respective entities and/or the entity-related information, and can create the embedding model (e.g., a trained AI-based embedding model) based at least in part on the results of the AI analysis, as more fully described herein.

At 806, with regard to a new (e.g., subsequent) entity associated with an electronic document (e.g., a new entity of or associated with a table, database, or freeform information of the electronic document) that is received subsequent to the group of electronic documents, a relationship between the new entity and one or more entities of the group of entities can be predicted based at least in part on the embedding model. With regard to the new entity, the DMC can predict or determine a relationship (e.g., an edge or a connection) between the new entity and one or more entities of the group of entities associated with the group of electronic documents based at least in part on the embedding model, such as more fully described herein.

At 808, candidate data modifications associated with the new entity can be determined based at least in part on the relationship between the new entity and the one or more entities. The DMC can determine the candidate data modifications (e.g., potential, recommended, or suggested data modifications) associated with the new entity based at least in part on the determined relationship between the new entity and the one or more entities.

At 810, the candidate data modifications can be ranked based at least in part on probabilities that the candidate data modifications are a correct data modification associated with the new entity. The DMC can rank (e.g., in order from highest rank to lowest rank) the candidate data modifications associated with (e.g., for) the new entity based at least in part on the respective probabilities that the respective candidate data modifications are the correct (e.g., the accurate) data modification to be implemented to modify information associated with the new entity.

At 812, data modification information relating to the ranking of the candidate data modifications associated with the new entity can be presented as an output. The DMC can present (e.g., communicate or display) or facilitate presenting the data modification information relating to the ranking as an output (e.g., via a communication device or interface component) for evaluation by the user or an evaluation component of the DMC.

At this point, the method 800 can proceed to reference point A, wherein, in accordance with various embodiments, the method 900 can proceed from reference point A to determine which candidate data modification (if any) is to be selected for use in modifying information of or associated with the new entity of the newly (e.g., subsequently) received electronic document.

FIG. 9 depicts a flow diagram of an example, non-limiting method 900 that can evaluate a group of candidate data modifications associated with an entity, select a desired candidate data modification from the group, and modify information of or associated with the entity based on the desired candidate data modification, in accordance with various aspects and embodiments of the disclosed subject matter. The method 900 can be implemented by a system that can comprise a DMC, a processor component, a data store, and/or another component(s). Alternatively, or additionally, a machine-readable medium can comprise executable instructions that, when executed by a processor, facilitate performance of the operations of the method 900. In accordance with various embodiments, the method 900 can proceed from reference point A to determine which candidate data modification (if any) is to be selected for use in modifying information of or associated with the subsequent entity of the subsequently received electronic document.

At 902, a determination can be made regarding whether a probability associated with a candidate data modification of the candidate data modifications associated with the new entity satisfies a defined threshold probability of being a correct data modification to be selected for use in modifying information of or associated with the new entity, based at least in part on the results of evaluating the data modification information relating to the ranking of the candidate data modifications associated with the new entity. The data modification information relating to the ranking of the candidate data modifications associated with the new entity can comprise information indicating the respective probabilities (or corresponding quality scores) that the respective candidate data modifications are the correct data modification to be used to modify the information associated with the new entity. The DMC (e.g., employing the evaluation component) can evaluate the data modification information, including the respective rankings and the respective probabilities (or the corresponding quality scores) associated with the respective candidate data modifications. Based at least in part on the results of evaluating the data modification information, the DMC can determine whether a probability (or corresponding quality score) associated with a candidate data modification (e.g., a highest ranking candidate data modification) of the candidate data modifications associated with the new entity satisfies (e.g., meets or exceeds; is greater than or equal to) the defined threshold probability (or a corresponding defined threshold quality score).

If it is determined that a probability associated with a candidate data modification of the candidate data modifications associated with the new entity satisfies the defined threshold probability, at 904, a determination can be made that the candidate data modification is the correct data modification to be selected for use in modifying information of or associated with the new entity. At 906, the candidate data modification associated with the probability can be selected as the correct data modification. At 908, information of or associated with the new entity can be modified based at least in part on the candidate data modification. If the DMC determines that a probability (or the corresponding quality score) associated with a candidate data modification of the candidate data modifications associated with the new entity satisfies the defined threshold probability (or the corresponding defined threshold quality score), the DMC can determine (e.g., automatically determine) that the candidate data modification is the correct data modification and is to be selected (e.g., automatically selected) for use in modifying information of or associated with the new entity. Accordingly, the DMC can select the candidate data modification as the correct data modification, and the DMC can modify the information associated with the new entity based at least in part on the candidate data modification. The electronic document, comprising the new entity that has been modified with the correct data modification, can be stored in the data store.

Referring again to reference numeral 902, if, at 902, it is determined that none of the probabilities associated with the candidate data modifications associated with the new entity satisfy the defined threshold probability, at 910, a determination can be that no automatic selection of a candidate data modification from the candidate data modifications is to be performed. If the DMC (e.g., employing the evaluation component) determines that none of the probabilities (or the corresponding quality scores) associated with the candidate data modifications associated with the new entity satisfy the defined threshold probability (or the corresponding defined threshold quality score), the DMC can determine that no automatic selection of a candidate data modification from the candidate data modifications with regard to the new entity is to be performed by the DMC.

In response to determining that no automatic selection of a candidate data modification from the candidate data modifications is to be performed by the DMC, at 912, selection information, which can indicate selection of a candidate data modification from the candidate data modifications, can be received from the user after the user evaluates the data modification information relating to the ranking of the candidate data modifications associated with the new entity.

At 914, a candidate data modification of the candidate data modifications associated with the new entity can be selected to be the correct data modification for use in modifying information of or associated with the new entity, based at least in part on the selection information received from the user. At 916, information of or associated with the new entity can be modified based at least in part on the candidate data modification. The DMC can receive the selection information from the user, via the communication device or interface component, wherein the selection information can indicate selection of the candidate data modification from the candidate data modifications associated with the new entity by the user. Based at least in part on the received selection information, the DMC can select the candidate data modification to be the correct data modification for use in modifying information of or associated with the new entity. The DMC can modify the information associated with the new entity based at least in part on the candidate data modification. The electronic document, comprising the new entity that has been modified with the correct data modification, can be stored in the data store.

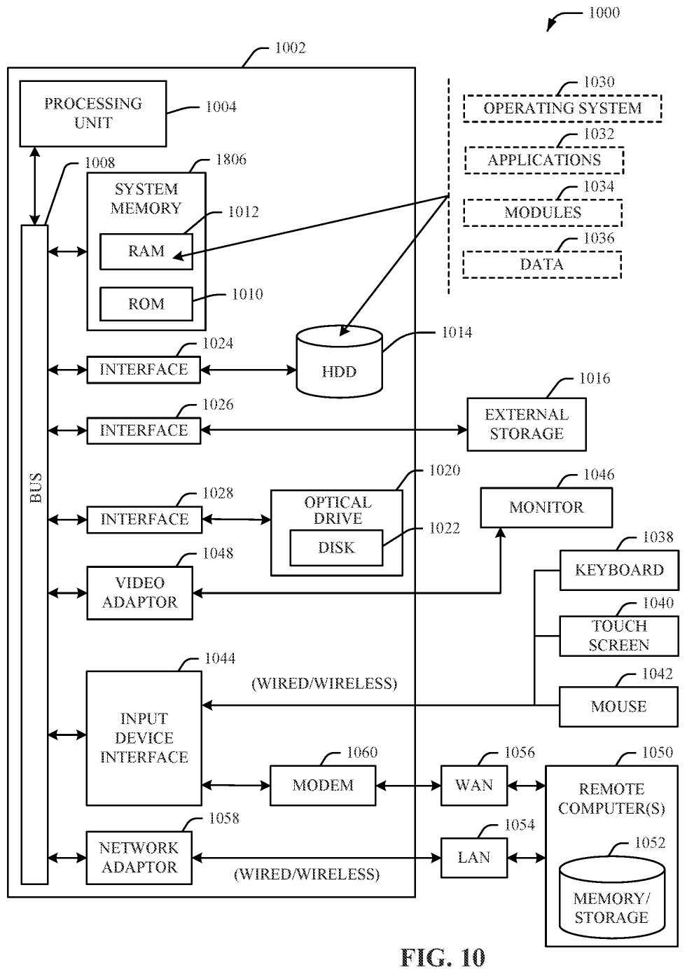

In order to provide additional context for various embodiments described herein, FIG. 10 and the following discussion are intended to provide a brief, general description of a suitable computing environment 1000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (BUD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056, e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like can refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “entity,” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

Systems, methods and/or machine-readable storage media for facilitating a two-stage downlink control channel for 5G systems are provided herein. Legacy wireless systems such as LTE, Long-Term Evolution Advanced (LTE-A), High Speed Packet Access (HSPA) etc. use fixed modulation format for downlink control channels. Fixed modulation format implies that the downlink control channel format is always encoded with a single type of modulation (e.g., quadrature phase shift keying (QPSK)) and has a fixed code rate. Moreover, the forward error correction (FEC) encoder uses a single, fixed mother code rate of 1/3 with rate matching. This design does not take into the account channel statistics. For example, if the channel from the BS device to the mobile device is very good, the control channel cannot use this information to adjust the modulation, code rate, thereby unnecessarily allocating power on the control channel. Similarly, if the channel from the BS to the mobile device is poor, then there is a probability that the mobile device might not be able to decode the information received with only the fixed modulation and code rate. As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise performing cell identification to identify candidate cells that can be associated with a table of a document, performing a character recognition analysis on information relating to a document, performing cell relationship identification to identify relationships between candidate cells, determining cell placement of candidate cells in a table, extracting or recreating a table of a document, transmitting or receiving data, establishing a connection between devices, determining intermediate results toward obtaining a result, or other actions. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, the DMC, model component, information extraction model, embedding model, AI component, weight component, data modification component, ranking component, decision component, version control component, alert component, operations manager component, processor component, data store, communication device, sensors, antennae, audio and/or visual output devices, or other devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
extracting, by a system comprising a processor, information regarding a group of entities and respective relationships between respective entities of the group of entities associated with a group of electronic documents based on an analysis of the group of electronic documents and entity-related information relating to the group of entities, wherein some of the respective entities of the group of entities are items of data;
determining, by the system, a model that embeds, and is trained to be representative of, the respective entities and the respective relationships between the respective entities based on the information regarding the group of entities and the respective relationships between the respective entities;
with regard to a subsequent entity associated with an electronic document that is received subsequent to the group of electronic documents, predicting, by the system, a relationship between the subsequent entity and an entity of the group of entities based on the model;
determining, by the system, a group of candidate data modifications associated with the subsequent entity based on the relationship between the subsequent entity and the entity;
ranking, by the system, respective candidate data modifications of the group of candidate data modifications based on respective probabilities that the respective candidate data modifications are a correct data modification; and
facilitating, by the system, outputting data modification information to be presented relating to the ranking of the respective candidate data modifications.

2. The method of claim 1, further comprising:
performing, by the system, the analysis, comprising an artificial intelligence analysis, of the information regarding the respective relationships between respective entities of the group of entities and the entity-related information relating to the group of entities, wherein the determining of the model comprises determining the model that embeds, and is trained to be representative of, the respective entities and the respective relationships between the respective entities based on a result of the artificial intelligence analysis.

3. The method of claim 1, wherein the items of data comprise a structured item of data and an unstructured item of data.

4. The method of claim 1, wherein a portion of the items of data is part of databases or tables, wherein the group of entities comprise the databases, the tables, and columns and rows of the databases or the tables, and wherein the entity-related information relating to the group of entities comprises data dictionary information, metadata, or unstructured textual information relating to or defining some of the respective entities of the group of entities.

5. The method of claim 1, wherein the group of entities comprises a first column, a first row, a first table, a second column, a second row, a second table, a data entry, a data dictionary, a first item of data, a second item of data, and a third item of data, and wherein the determining of the respective relationships between the respective entities comprises:
determining a first relationship between the first column of the first table and the second column of the second table based on column name data or the first item of data associated with the first column and the second column;
determining a second relationship between the first row of the first table and the second row of the second table based on row name data or the second item of data associated with the first row and the second row; or
determining a third relationship between the first column of the first table and the data entry in the data dictionary based on the column name data of the first column or the third item of data of the data entry.

6. The method of claim 1, further comprising:
assigning, by the system, respective weight values to the respective entities or the respective relationships between the respective entities based on respective entity types of the respective entities or based on respective strengths of the respective relationships,
wherein the determining of the group of candidate data modifications associated with the subsequent entity comprises determining the group of candidate data modifications associated with the subsequent entity based on the respective weight values assigned to the respective entities or the respective relationships between the respective entities, and
wherein the respective probabilities that the respective candidate data modifications are the correct data modification are determined based on the respective weight values assigned to the respective entities or the respective relationships between the respective entities.

7. The method of claim 1, wherein the subsequent entity is a name of a table, a database, a column, or a row, an abbreviation of the name, or an acronym of the name, and wherein the group of candidate data modifications relate to the name, the abbreviation, or the acronym.

8. The method of claim 1, wherein the subsequent entity is an item of data, and wherein the group of candidate data modifications relate to candidate data values of the item of data.

9. The method of claim 1, wherein facilitating, by the system, outputting comprises facilitating presenting the data modification information relating to the ranking of the respective candidate data modifications via an interface or a communication device associated with a user identity, and further comprising:
receiving, by the system, selection data indicating a selection of a candidate data modification of the respective candidate data modifications; and
in response to the selection of the candidate data modification, modifying, by the system, the subsequent entity to correspond to the candidate data modification.

10. The method of claim 1, further comprising:
generating, by the system, a modified electronic document, a modified database, or a modified table based on the modifying of the subsequent entity in the electronic document, a database, or a table;
storing, by the system, in a data store, the electronic document, the database, or the table as a previous version of the electronic document, the database, or the table; and
storing, by the system, the modified electronic document, the modified database, or the modified table in the data store.

11. The method of claim 1, wherein the group of candidate data modifications comprises a first candidate data modification and a second candidate data modification, wherein the first candidate data modification is a highest ranked candidate data modification based on the ranking, wherein the candidate data modification is the second candidate data modification, wherein the respective probabilities comprise a first probability and a second probability, and wherein the method further comprises:
in response to feedback information indicating the selection of the second candidate data modification, determining, by the system, that the second candidate data modification is not the highest ranked candidate data modification based on the ranking; and
in connection with a next entity that corresponds to the subsequent entity, and in response to determining that the second candidate data modification is not the highest ranked candidate data modification,
decreasing, by the system, the first probability associated with the first candidate data modification, and
increasing, by the system, the second probability associated with the second candidate data modification.

12. The method of claim 1, wherein the group of candidate data modifications comprises a first candidate data modification and a second candidate data modification, wherein the first candidate data modification is a highest ranked candidate data modification based on the ranking, wherein the candidate data modification is the first candidate data modification, wherein the respective probabilities comprise a first probability and a second probability, and wherein the method further comprises:
in response to feedback information indicating the selection of the first candidate data modification, determining, by the system, that the first candidate data modification is the highest ranked candidate data modification based on the ranking; and
in connection with a next entity that corresponds to the subsequent entity, and in response to determining that the first candidate data modification is the highest ranked candidate data modification,
determining, by the system, the first probability associated with the first candidate data modification is to be increased or is to remain at the first probability, and
determining, by the system, the second probability associated with the second candidate data modification is to be decreased or is to remain at the second probability.

13. The method of claim 1, further comprising:
determining, by the system, that a candidate data modification of the respective candidate data modifications has a highest ranking relative to other rankings associated with other candidate data modifications of the respective candidate data modifications based on the data modification information relating to the ranking of the respective candidate data modifications;
determining, by the system, that a probability associated with the candidate data modification satisfies a defined threshold probability;
in response to determining that the probability associated with the candidate data modification satisfies the defined threshold probability, selecting, by the system, the candidate data modification; and
modifying, by the system, the subsequent entity to correspond to the candidate data modification.

14. A system, comprising:
a processor; and
a memory that stores executable instructions that, when executed by the processor, facilitate performance of operations, comprising:
extracting information regarding a group of entities and respective edges between respective entities of the group of entities associated with a group of electronic documents based on an analysis of the group of electronic documents and entity-related information relating to the group of entities, wherein some of the group of entities are items of data;
determining a trained model that embeds, and is representative of, the respective entities and the respective edges between the respective entities based on the information regarding the group of entities and the respective edges between the respective entities;
with regard to a subsequent entity associated with an electronic document that is received subsequent to the group of electronic documents, predicting an edge between the subsequent entity and an entity of the group of entities based on the trained model;
determining a group of suggested data changes associated with the subsequent entity based on the edge between the subsequent entity and the entity; and
determining a ranking of respective suggested data changes of the group of suggested data changes based on respective likelihoods that the respective suggested data changes are an accurate data change, wherein data change information relating to the ranking of the respective suggested data changes is communicated as an output.

15. The system of claim 14, wherein the operations further comprise:
performing the analysis, comprising applying an artificial intelligence process, of the group of entities and the entity-related information relating to the group of entities, wherein the determining of the trained model comprises determining the trained model that embeds, and is representative of, the respective entities and the respective edges between the respective entities based on a result of the applying of the artificial intelligence process.

16. The system of claim 14, wherein the respective edges correspond to or indicate respective relationships between the respective entities, wherein a portion of the items of data is part of tables, wherein the group of entities comprise the tables, and columns and rows of the tables, and wherein the entity-related information relating to the group of entities comprises data dictionary data, metadata, or unstructured textual data relating to or defining some of the respective entities of the group of entities.

17. The system of claim 14, wherein the operations further comprise:
communicating the data change information relating to the ranking of the respective suggested data changes to an interface or a communication device associated with a user identity;
receiving selection data indicating a selection of a suggested data change of the respective suggested data changes; and
in response to the selection of the suggested data change, modifying the subsequent entity to correspond to the suggested data change.

18. The system of claim 14, wherein the operations further comprise:
determining that a suggested data change of the respective suggested data changes has a highest ranking relative to other rankings associated with other suggested data changes of the respective suggested data changes based on the data change information relating to the ranking of the respective suggested data changes;
determining that a probability associated with the suggested data change satisfies a defined threshold probability;
in response to determining that the probability associated with the suggested data change satisfies the defined threshold probability, selecting the suggested data change over the other suggested data changes; and
modifying the subsequent entity to correspond to the suggested data change.

19. A non-transitory machine-readable medium, comprising executable instructions that, when executed by a processor, facilitate performance of operations, comprising:
identifying information regarding a group of nodes and respective relationships between respective nodes of the group of nodes associated with a group of electronic documents based on an analysis of the group of nodes and node-related information relating to the group of nodes, wherein some of the respective nodes of the group of nodes are data elements;
determining a trained model that corresponds to the respective nodes and the respective relationships between the respective nodes based on the information regarding the group of nodes and the respective relationships between the respective nodes;
with regard to a subsequent node associated with an electronic document that is received subsequent to the group of electronic documents, predicting a relationship between the subsequent node and a node of the group of nodes based on the trained model;
determining a group of recommended data modifications associated with the subsequent node based on the relationship between the subsequent node and the node; and
determining a ranking of respective recommended data modifications of the group of recommended data modifications based on respective probabilities that the respective recommended data modifications are a correct data modification, wherein data modification information relating to the ranking of the respective recommended data modifications is communicated as an output.

20. The non-transitory machine-readable medium of claim 19, wherein the operations further comprise:
communicating the data modification information relating to the ranking of the respective recommended data modifications to an interface or a communication device associated with a specified user identity;
receiving selection data indicating a selection of a recommended data modification of the respective recommended data modifications; and
in response to the selection of the recommended data modification, changing the subsequent entity to correspond to the recommended data modification.
